(19) United States
(12) Patent Application Publication
(10) Pub. No.: US 2004/0198439 A1
(43) Pub. Date: Oct. 7, 2004

(54) Device and method for displaying pictures in a mobile terminal

(76) Inventors: Dong-Ryong Kim, Gumi-si (KR); In-Kyu Choi, Dong-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/813,280

(22) Filed: Mar. 31, 2004

(30) Foreign Application Priority Data
Apr. 1, 2003 (KR) 2003-20539
Jun. 16, 2003 (KR) 2003-38650

(51) Int. Cl. H04Q 7/20; H04M 1/00; H04B 1/38

(52) U.S. Cl. 455/556.1; 455/566; 455/550.1

(57) ABSTRACT

An apparatus and method for displaying a picture in a mobile terminal is provided. The apparatus and method comprises a direction detecting section comprising at least one magnet fixed within the mobile terminal and a plurality of sensors for detecting the magnet in order to detect the direction in which the mobile terminal is turned and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

### PRIORITY

This application claims priority to two applications both entitled “Device and Method for Displaying Pictures in Mobile Terminal”, one filed with the Korean Intellectual Property Office on Apr. 1, 2003 and assigned Ser. No. 2003-20539 and the other filed with the Korean Intellectual Property Office on Jun. 16, 2003 and assigned Ser. No. 2003-38650, the entire contents of which are hereby incorporated by reference.

### BACKGROUND OF THE INVENTION

1. Field of the Invention

The present invention relates to a device and a method for displaying a picture in a mobile terminal, and more particularly to a device and a method for detecting the direction in which a mobile terminal is turned and controlling the display direction of a picture.

2. Description of the Related Art

Mobile communication terminals with data capabilities are becoming more popular than voice based mobile telephones for performing high-speed data transmission. IMT-2000 mobile communication network services enable high-speed data transmission as well as voice communication using mobile terminals. In other words, mobile terminals can process both packet data and image data in an IMT-2000 network. Mobile terminals equipped with a camera or a TV receiver can also display moving pictures. For example, a mobile terminal with an embedded camera can take pictures and display them as moving or still pictures. Also, it is possible to send the pictures to another mobile terminal. Similarly, a mobile terminal with a TV receiver can display received video or image signals.

However, mobile terminals display pictures in a single fixed direction, regardless of the position of the terminals. Accordingly, viewers can see the pictures displayed only in a fixed direction on the mobile terminals. When a terminal is turned at a certain angle relative to the plane on which it stands, the resulting orientation of the displayed pictures does not match that of the pictures perceived by the viewer. More specifically, when a terminal is turned by an angle of 90°, pictures displayed are also turned 90°. The viewer has to tilt his or her head to one side at the same angle as the terminal to see normal pictures.

### SUMMARY OF THE INVENTION

Accordingly, the present invention has been made to solve the above-mentioned problems occurring in the prior art, and one object of the present invention is to provide a device and a method for automatically controlling the display direction of pictures on a mobile terminal to enable a viewer to see the pictures in an upright position, regardless of the direction in which the mobile terminal is turned.

Another object of the present invention is to provide a mobile terminal comprising sensors for detecting the display direction of pictures and capable of controlling the display direction according to the output from the sensors, thereby always producing the pictures in an upright direction, regardless of the direction in which the terminal is turned, and a method for controlling the display direction in the mobile terminal.

Still another object of the present invention is to provide a device and a method for displaying a picture on a mobile terminal in an upright direction to the eyes of a viewer, regardless of the direction in which the terminal is turned, and adjusting the size of the picture according to the direction of a display section of the terminal.

In accordance with one aspect of the invention for accomplishing the above objects, there is provided a device for displaying a picture in a mobile terminal, which comprises a direction detecting section comprising at least one magnet fixed within the mobile terminal and a plurality of sensors for detecting the magnet in order to detect the direction in which the mobile terminal is turned and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with another aspect of the invention, there is provided a device for displaying a picture in a mobile terminal, which comprises a camera module for photographing an image signal; an image processing section for processing the image signal photographed by the camera module in a display picture size; a direction detecting section comprising at least one magnet fixed within the mobile terminal and a plurality of sensors for detecting the magnet in order to detect the direction in which the mobile terminal is turned and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with still another aspect of the invention, there is provided a device for displaying a picture in a mobile terminal, which comprises a tuner for receiving a composite television video signal broadcast on a selected channel; a decoder for decoding the composite video signal to generate an analog video signal and a synchronizing signal; a video processing section for converting the analog video signal into digital video data, processing the digital video data into a frame size and outputting a frame video signal and user data in the frame; a direction detecting section comprising at least one magnet fixed within the mobile terminal and a plurality of sensors for detecting the magnet in order to detect the direction in which the mobile terminal is turned and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with still another aspect of the invention, there is provided a device for displaying a picture in a mobile terminal, which comprises a direction detecting section comprising at least one projection fixed on the mobile terminal and a plurality of sensors for detecting the projection in order to detect the direction in which the mobile terminal is turned and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with still another aspect of the invention, there is provided a device for displaying a picture in a mobile terminal, which comprises a camera module for photographing an image signal; an image processing section for processing the image signal photographed by the camera module in a display picture size; a direction detecting section comprising at least one projection fixed on the mobile terminal and a plurality of sensors for detecting the projection in order to detect the direction in which the mobile terminal is turned and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with still another aspect of the invention, there is provided a device for displaying a picture in a mobile terminal, which comprises a tuner for receiving a composite television video signal broadcast on a selected channel; a decoder for decoding the composite video signal to generate an analog video signal and a synchronizing signal; a video processing section for converting the analog video signal into a digital video data, processing the digital video data in a frame size and outputting a frame video signal and user data in the frame; a direction detecting section comprising at least one projection fixed on the mobile terminal and a plurality of sensors for detecting the projection in order to detect the direction in which the mobile terminal is turned and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with still another aspect of the invention, there is provided a device for displaying a picture in a mobile terminal, which comprises a direction detecting section comprising at least one projection and at least one magnet fixed on or in the mobile terminal and a plurality of sensors for detecting the projection or the magnet in order to detect the direction in which the mobile terminal is turned and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with still another aspect of the invention, there is provided a device for displaying a picture in a mobile terminal, which comprises a camera module for photographing an image signal; an image processing section for processing the image signal photographed by the camera module in a display picture size; a direction detecting section comprising at least one projection and at least one magnet fixed on or in the mobile terminal and a plurality of sensors for detecting the projection or the magnet in order to detect the direction in which the mobile terminal is turned and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with still another aspect of the invention, there is provided a device for displaying a picture in a mobile terminal, which comprises a tuner for receiving a composite television video signal broadcast on a selected channel; a decoder for decoding the composite video signal to generate an analog video signal and a synchronizing signal; a video processing section for converting the analog video signal into a digital video data, processing the digital video data in a frame size and outputting a frame video signal and user data in the frame; a direction detecting section comprising at least one projection and at least one magnet fixed on or in the mobile terminal and a plurality of sensors for detecting the projection or the magnet in order to detect the direction in which the mobile terminal is turned and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with still another aspect of the invention, there is provided a device for displaying a picture in a mobile terminal, which comprises a direction detecting section comprising a magnet fixed within the mobile terminal and a plurality of sensors for detecting the polarity of the magnet in order to detect the direction in which the mobile terminal is turned and generate a first direction detecting signal, a second direction detecting signal, a third direction detecting signal, and a fourth direction detecting signals; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with still another aspect of the invention, there is provided a device for displaying a picture in a mobile terminal, which comprises a direction detecting section comprising a magnet fixed within the mobile terminal, first and second sensors for detecting the N pole of the magnet and third and fourth sensors for detecting the S pole of the magnet in order to detect the direction in which the mobile terminal is turned according to the pole detected by one of the four sensors and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In accordance with still another aspect of the invention, there is provided a device for displaying a picture in a mobile terminal, which comprises a direction detecting section comprising a magnet fixed within the mobile terminal and first and second sensors for detecting the N and S poles of the magnet in order to detect the direction in which the mobile terminal is turned according to the pole detected by one of the two sensors and generate a first direction detecting signal, a second direction detecting signal, a third direction detecting signal, and a fourth direction detecting signal; a control section for outputting picture data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated; and a display section for displaying the picture data.

In order to accomplish the above objects of the present invention, one aspect of the invention provides a method for displaying a picture on a mobile terminal which includes a direction detecting section comprising at least one fixed magnet and a plurality of sensors for detecting the magnet. The method comprising the steps of detecting a direction signal indicating the direction in which the mobile terminal is turned, using the sensors for detecting the magnet; when no direction signal is received from the sensors, making a determination as to when a first direction signal is detected and outputting and displaying picture data in an upright direction; when a second direction signal is detected, outputting and displaying the picture data in a direction turned 90° counter-clockwise; when a third direction signal is detected, displaying the picture data in a direction turned 180°; and when a fourth direction signal is detected, outputting and displaying the picture data in a direction turned 270° counter-clockwise.

In accordance with another aspect of the invention, there is provided a method for displaying a picture on a mobile terminal which includes a direction detecting section comprising at least one fixed magnet and a plurality of sensors for detecting the magnet. The method comprising the steps of detecting a direction signal indicating the direction in which the mobile terminal is turned, using a sensor contacting the magnet; when no direction signal is received from the sensors, making a determination as to when a first direction signal is detected and outputting and displaying picture data in an upright direction; when a second direction signal is detected, generating full size picture data and displaying the picture data in a direction turned 90° counter-clockwise; when a third direction signal is detected, displaying the picture data in a direction turned 180°; and when a fourth direction signal is detected, generating full size picture data and displaying the picture data in a direction turned 270° counter-clockwise.

In accordance with still another aspect of the invention, there is provided a method for displaying a picture on a mobile terminal which includes a direction detecting section comprising at least one projection and a plurality of sensors for detecting the projection. The method comprising the steps of detecting a direction signal indicating the direction in which the mobile terminal is turned, using a sensor contacting the projection; when no direction signal is received from the sensors, making a determination as to when a first direction signal is detected and outputting and displaying picture data in an upright direction; when a second direction signal is detected, outputting and displaying the picture data in a direction turned 90° counter-clockwise; when a third direction signal is detected, displaying the picture data in a direction turned 180°; and when a fourth direction signal is detected, outputting and displaying the picture data in a direction turned 270° counter-clockwise.

In accordance with still another aspect of the invention, there is provided a method for displaying a picture on a mobile terminal which includes a direction detecting section comprising at least one projection and a plurality of sensors for detecting the projection. The method comprising the steps of detecting a direction signal indicating the direction in which the mobile terminal is turned, using a sensor contacting the projection; when no direction signal is received from the sensors, making a determination as to when a first direction signal is detected and outputting and displaying picture data in an upright direction; when a second direction signal is detected, generating full size picture data and displaying the picture data in a direction turned 90° counter-clockwise; when a third direction signal is detected, displaying the picture data in a direction turned 180°; and when a fourth direction signal is detected, generating full size picture data and displaying the picture data in a direction turned 270° counter-clockwise.

In accordance with still another aspect of the invention, there is provided a method for displaying a picture on a mobile terminal which includes a direction detecting section comprising at least one projection, at least one magnet and a plurality of sensors for detecting the projection or the magnet. The method comprising the steps of detecting a direction signal indicating the direction in which the mobile terminal is turned, using a sensor contacting the projection or the magnet; when no direction signal is received from the sensors, making a determination as to when a first direction signal is detected and outputting and displaying picture data in an upright direction; when a second direction signal is detected, outputting and displaying the picture data in a direction turned 90° counter-clockwise; when a third direction signal is detected, displaying the picture data in a direction turned 180°; and when a fourth direction signal is detected, outputting and displaying the picture data in a direction turned 270° counter-clockwise.

In accordance with still another aspect of the invention, there is provided a method for displaying a picture on a mobile terminal which includes a direction detecting section comprising at least one projection, at least one magnet and a plurality of sensors for detecting the projection or the magnet. The method comprising the steps of detecting a direction signal indicating the direction in which the mobile terminal is turned, using a sensor contacting the projection or the magnet; when no direction signal is received from the sensors, making a determination as to when a first direction signal is detected and outputting and displaying picture data in an upright direction; when a second direction signal is detected, generating full size picture data and displaying the picture data in a direction turned 90° counter-clockwise; when a third direction signal is detected, displaying the picture data in a direction turned 180°; and when a fourth direction signal is detected, generating full size picture data and displaying the picture data in a direction turned 270° counter-clockwise.

In accordance with still another aspect of the invention, there is provided a method for displaying a picture on a mobile terminal which includes a direction detecting section comprising a fixed magnet and a plurality of sensors for detecting the polarity of the magnet. The method comprising the steps of detecting the polarity of the magnet by one of the sensors; detecting a direction signal indicating the direction in which the mobile terminal is turned according to the detected polarity; when a first direction signal is detected, outputting and displaying picture data in an upright direction; when a second direction signal is detected, displaying the picture data in a direction turned 90° counter-clockwise; when a third direction signal is detected, displaying the picture data in a direction turned 180°; and when a fourth direction signal is detected, displaying the picture data in a direction turned 270° counter-clockwise.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a mobile communication terminal according to an embodiment of the present invention;

FIG. 2 is a diagram illustrating a display section of the mobile terminal in FIG. 1;

FIGS. 3A through 3E are block diagrams illustrating an operation of a mobile terminal according to a first embodiment of the present invention;

FIGS. 4A through 4E are block diagrams illustrating an operation of a mobile terminal according to a second embodiment of the present invention;

FIGS. 5A through 5E are block diagrams illustrating an operation of a mobile terminal according to a third embodiment of the present invention;

FIG. 6 is a flow chart illustrating a process of controlling a display operation of a mobile terminal according to embodiments of the present invention;

FIG. 7 is a flow chart illustrating another process of controlling a display operation of a mobile terminal according to embodiments of the present invention;

FIGS. 8A through 8E are block diagrams illustrating an operation of a mobile terminal according to an embodiment of the present invention;

FIG. 9 is a flow chart illustrating a process of controlling a display operation of a mobile terminal according to another embodiment of the present invention;

FIGS. 10A through 10E are views for explaining the operation of a mobile terminal according to an embodiment of the present invention; and

FIG. 11 is a flow chart illustrating a process of controlling a display operation of a mobile terminal according to yet another embodiment of the present invention.

### DETAILED DESCRIPTION OF THE PREFERRED EMBODIMENTS

Hereinafter, embodiments of the present invention will be described with reference to the accompanying drawings. In the drawings, the same element, although depicted in different drawings, will be designated by the same reference numeral or character. Also, in the following description of the embodiments of the present invention, a detailed description of known functions and configurations incorporated herein will be omitted for conciseness.

In the following description of the various embodiments of the present invention, a mobile terminal with a camera or a TV receiver are used as examples. However, the present invention is equally applicable to all general mobile terminals having neither a camera nor a TV receiver.

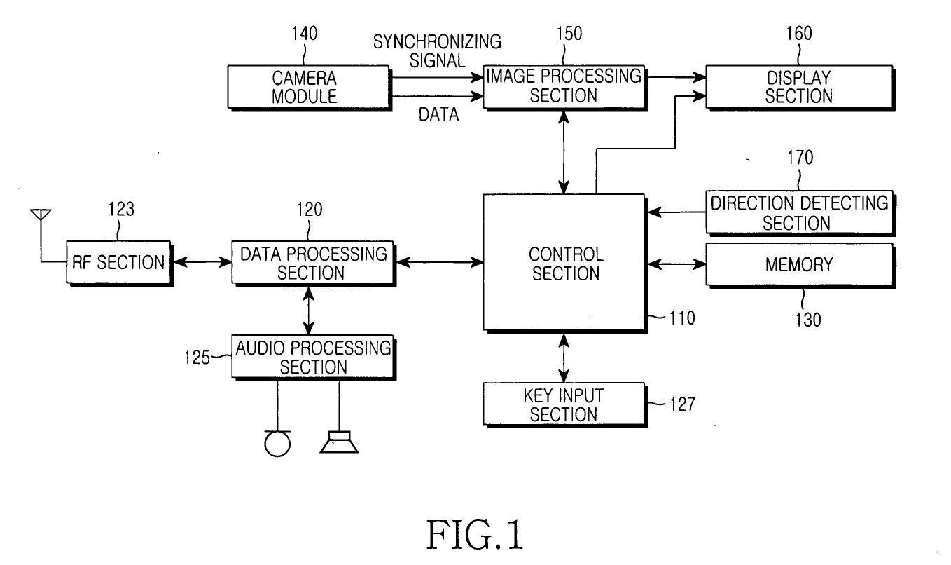

FIG. 1 is a block diagram showing the structure of a mobile communication terminal equipped with a camera according to an embodiment of the present invention.

Referring to FIG. 1, an RF section 123 performs a wireless communication function. The RF section 123 comprises a RF transmitter (not shown) for performing upward conversion and amplification of the frequency of a signal, which is being transmitted, and an RF receiver (not shown) for amplifying a signal, which is being received, with low noise and performing a downward conversion of the frequency of the signal. A data processing section 120 comprises a transmitter (not shown) for coding and modulating a signal which is being transmitted and a receiver (not shown) for demodulating and decoding a signal which is being received. The data processing section 120 typically include a modem and a codec. The codec comprises a data codec for processing packet data and an audio codec for processing an audio signal such as a speech signal. An audio processing section 125 reproduces an audio signal output from the audio codec of the data processing section 120 or transmits an audio signal generated from a microphone to the audio codec of the data processing section 120.

A key input section 127 is provided with keys for inputting numbers and characters and function keys for setting up various functions. The key input section 127 may additionally include a picture direction control key for manually controlling the display direction of pictures. A memory 130 can comprise a program memory and a data memory. The program memory includes programs for controlling the display direction of pictures on the mobile terminal to enable a viewer to see the pictures in an upright position. Also, the data memory can temporarily store data generated during implementation of the above programs.

A control section 110 controls the overall operations of the mobile terminal. The control section 110 may include the data processing section 120. The control section 110 detects the display direction of pictures and controls the mobile terminal to display the pictures in an upright direction in respect to the eyes of the viewer.

A camera module 140 is used to take pictures of an object on which its lens focuses. The camera module 140 comprises a camera sensor for converting a photographed optical signal into an electric signal and a signal processor for converting an analog image signal photographed by the camera sensor into digital data. Assuming that the camera sensor is a charge coupled device (CCD) sensor, the signal processor can be a digital signal processor (DSP). The camera sensor and the signal processor can be either integrated into a single element or separated as independent elements.

An image processing section 150 generates picture data for displaying an image signal output from the camera module 140. The image processing section 150 processes image signals output from the camera module 140 in frames. Also, the image processing section 150 adjusts the frame image data to conform to the features, such as size and resolution, which are displayable on the display section 160, and outputs the adjusted frame image data. The image processing section 150 comprises an image codec, and compresses the frame image data displayed on the display section 160 in a preset manner or restores the compressed frame image data to the original frame image data. The image codec is selected from a variety of still or moving picture codecs, such as Joint Photographic Experts Group (JPEG) codec, Moving Pictures Expert Group 4 (MPEG4) codec or Wavelet codec. The image processing section 150 has an on screen display (OSD) function. The image processing section 150 can output OSD data according to the displayed picture size under the control of the control section 110.

The display section 160 displays image data output from the image processing section 150 or user data output from the control section 110. The display section 160 can be a Liquid Crystal Display (LCD) comprising an LCD controller (not shown), a memory (not shown) for storing image data and an LCD device (not shown). When the LCD is a touch screen, it can serve as a key input section.

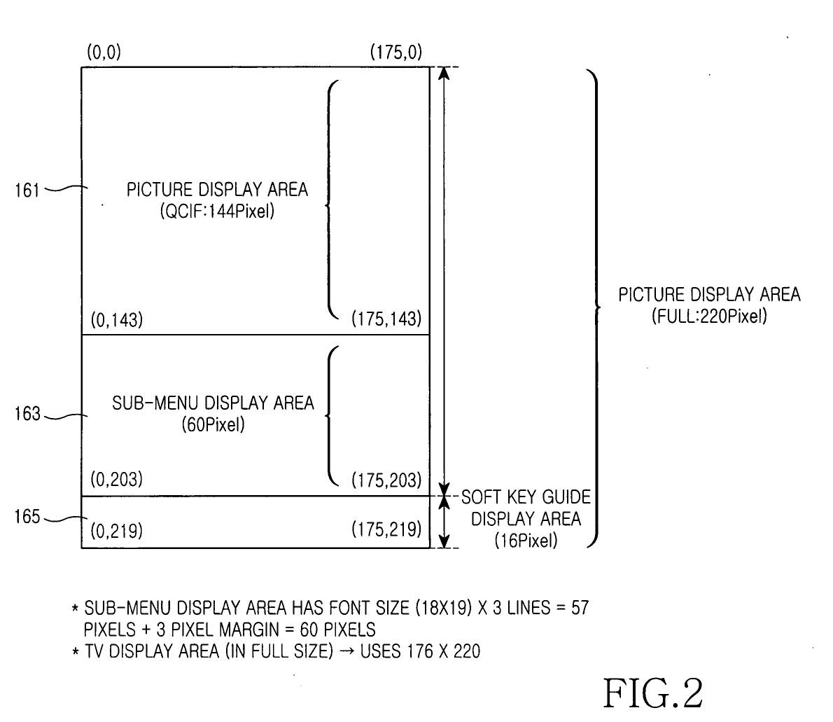

FIG. 2 is a diagram illustrating a display section 160 according to an embodiment of the present invention.

Referring to FIG. 2, the display section 160 has a first display area 161 for displaying image signals and a second display area 163 for displaying user data. The display section 160 may additionally have a third display area 165 for displaying information about soft keys for setting up a menu to enter a display mode. In an embodiment of the present invention, it is assumed that the display section 160 includes all of the first to third display areas 161 to 165. The first display area 161 displays an image in Quarter Common Intermediate Format (QCIF) size. The second display area 163 displays user data. The third display area displays information for guiding a user in operating the soft keys. It is assumed that the three display areas of the display section 160 each have different sizes as shown in FIG. 2. The first display area 161 displays a QCIF picture having 176×144 pixels in a normal state. Also, it is assumed that a full picture displayed on the entire display section 160 has 176×220 pixels.

Assuming that the second display area 163 for displaying user data and sub-menus has a size of 176×60 pixels which is a font size (18×19 pixels)×3 lines, character data comprising 60 characters (pixels) can be displayed in the second display area 163. If a margin corresponding to a size of 3 characters is given, a total of 57 characters can be displayed. If user data and menus are stored in the memory 131 according to the characteristics of the second display area 163, they can be effectively displayed in the picture display mode.

The picture display mode refers to a mode showing image data photographed by a camera module of a mobile camera phone or television signals received by a TV receiver-equipped mobile terminal. The photographed image data or the television signals are displayed in the first display area 161. The user data depending on such display is shown in the second display area 163.

A direction detecting section 170 (see FIG. 1) detects the direction the mobile terminal is turned and outputs a direction detecting signal to the control section 110. The direction detecting section 170 can be formed using various structures.

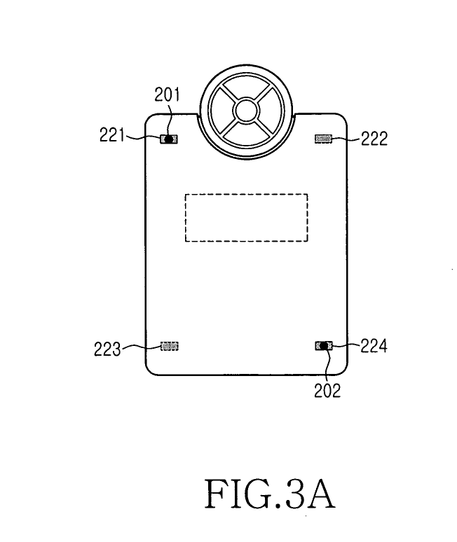

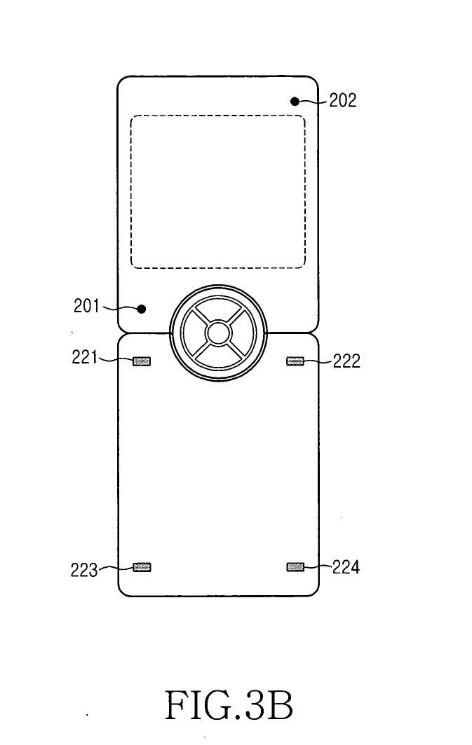

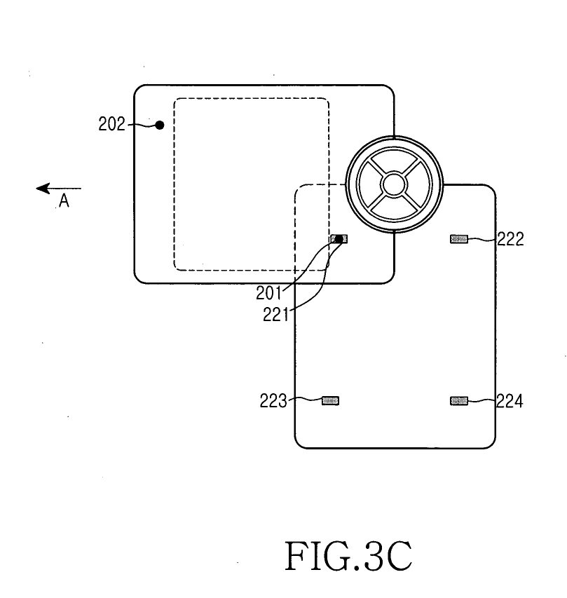

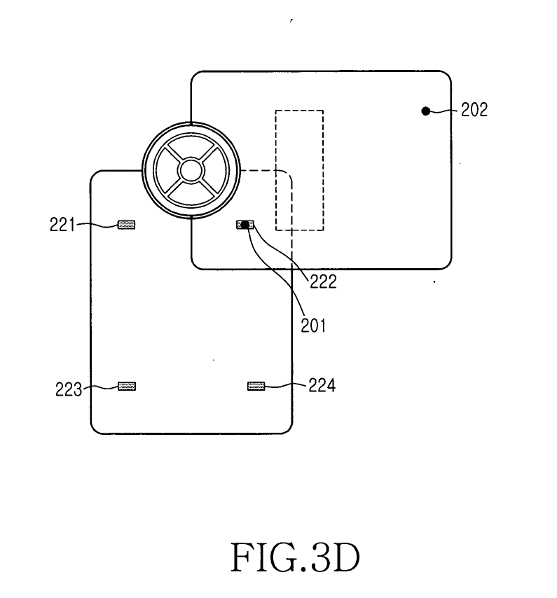

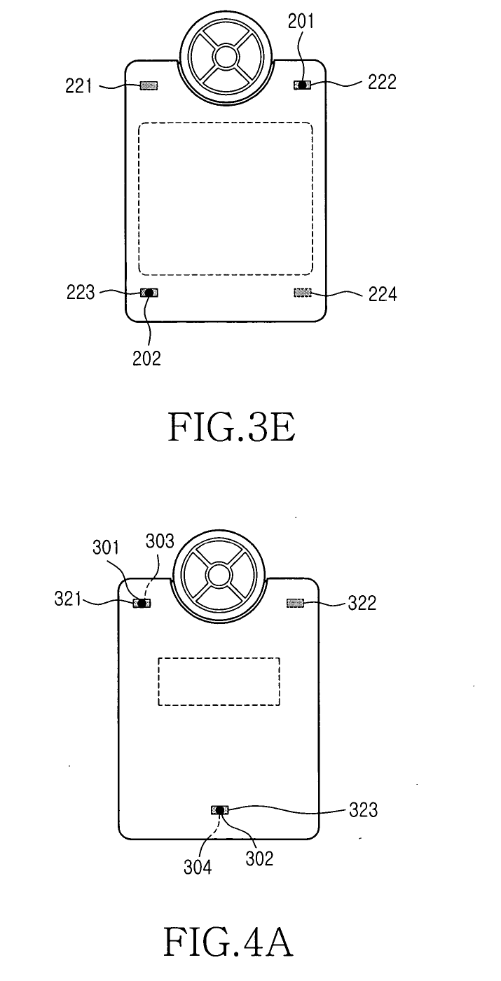

FIGS. 3A through 3E are block diagrams illustrating an operation of the direction detecting section 170 according to a first embodiment of the present invention. In the first embodiment, it is assumed that the mobile terminal has four direction sensors in a main housing and two fixed magnets in a folder housing. It is also assumed that the direction sensors for detecting the four directions of the display section 160 of the mobile terminal are Hall sensors (Hall effect ICs). The positions and numbers of the sensors and the magnets may vary depending on the types of mobile terminals.

Referring to FIGS. 3A through 3E, the direction detecting section 170 comprises two magnets 201 and 202 fixed within the folder of the mobile terminal and four Hall sensors 221, 222, 223, and 224 mounted in the main housing to detect the magnets 201 and 202 and generate a direction detecting signal. However, there is no limitation on the positions of the magnets and the sensors. It is also possible to mount the magnets in the main housing and the sensors in the folder. For explanatory convenience, it is assumed that the folders in FIGS. 3B through 3E are turned respectively in a first direction (turned 0°), a fourth direction (turned 270° clockwise in an opened state), a second direction (turned 90° counter-clockwise in a closed state) and a third direction (turned 180° in an opened state).

When the folder of the mobile terminal is closed as shown in FIG. 3A, the first and fourth Hall sensors 221 and 224 simultaneously detect the first and second magnets 201 and 202, respectively. If the folder of the mobile terminal is opened so that the first and fourth Hall sensors 221 and 224 cannot detect the first and second magnets 201 and 202 or if none of the Hall sensors outputs a direction detecting signal, the direction detecting section 170 will generate a first direction detecting signal. When the second Hall sensor 222 detects the first magnet 201 as shown in FIG. 3D, a second direction detecting signal is generated. In the open position and with the folder aligned in the direction of A, when the first Hall sensor 221 detects the first magnet 201 as shown in FIG. 3C, a fourth direction detecting signal is generated. Also, when the second and third Hall sensors 222 and 223 simultaneously detect the first and second magnets 201 and 202 as shown in FIG. 3E, the direction detecting section 170 generates a third direction detecting signal.

The operation of a mobile terminal having the structure as shown in FIG. 1 will be explained in more detail with reference to FIGS. 2 and 3. When the folder is opened, the control section 110 controls the display section 160 to be in a display mode. The “display mode” includes both a communication mode and a mode for displaying image data photographed by the camera module 140.

In the display mode, the first to fourth Hall sensors 221, 222, 223 and 224 of the direction detecting section 170 detect the magnets 201 and 202 fixed in the mobile terminal according to the direction in which the folder of the mobile terminal is turned. The control section 110 reads the output from the direction detecting section 170 to determine the positional state (direction) of the folder of the mobile terminal.

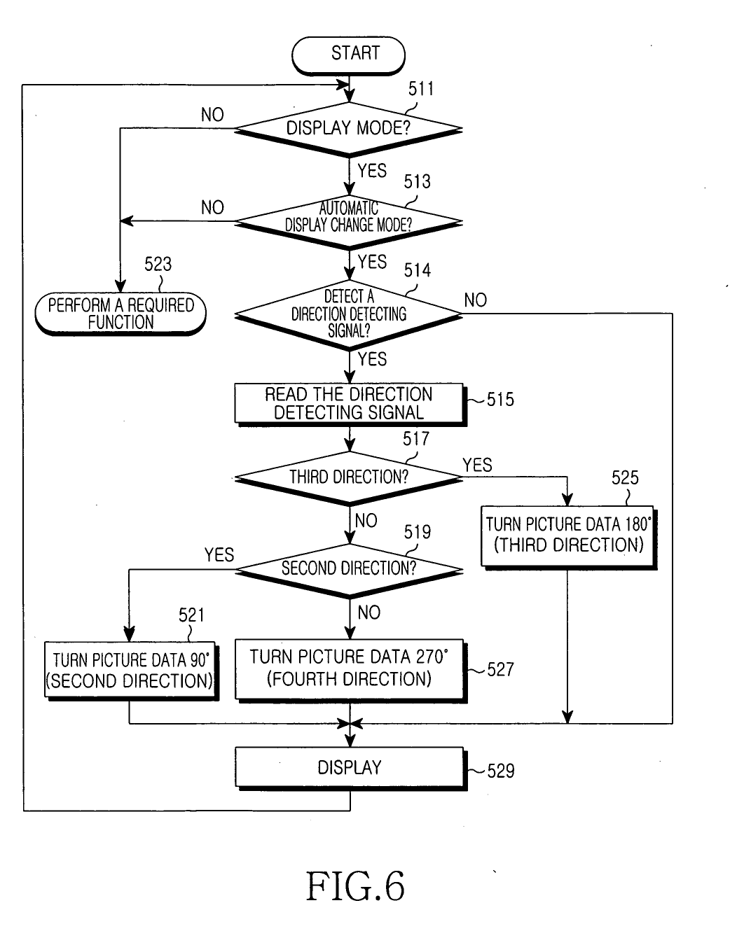

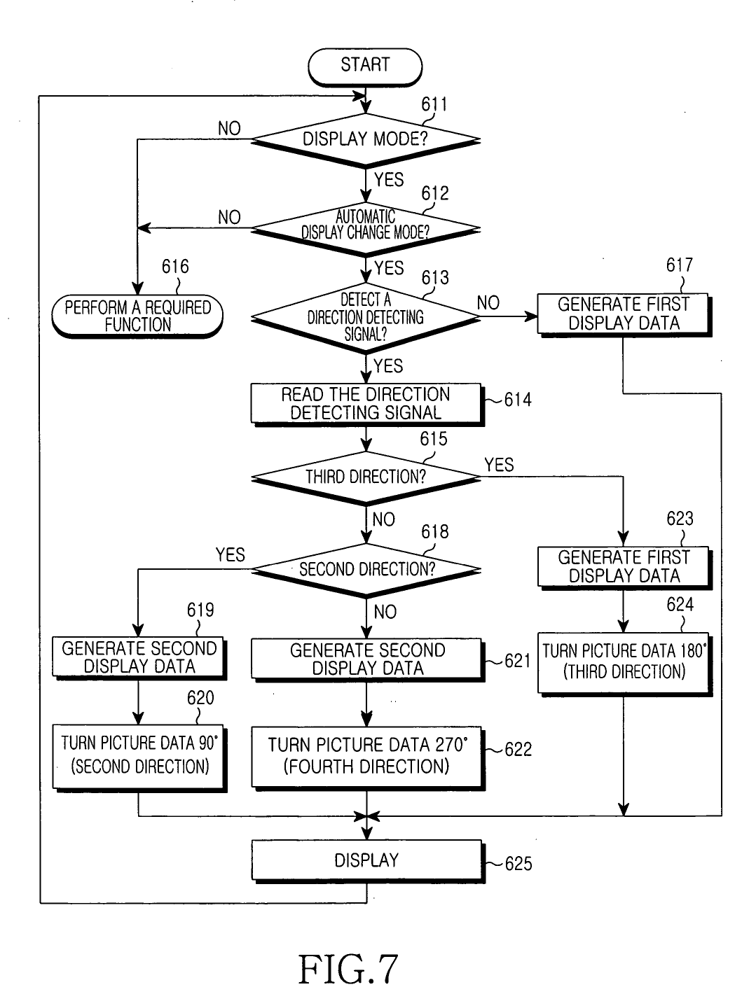

If no output from the Hall sensors 221, 222, 223 and 224 is detected, the control section 110 will determine that the folder of the mobile terminal is turned 0° and opened in a normal upright direction. If an output from the second Hall sensor 222 is detected, the control section 110 will determine that the folder of the mobile terminal is turned 90° counter-clockwise in a closed state. If an output from the first Hall sensor 221 is detected, the control section 110 will determine that the folder of the mobile terminal is turned 270° clockwise in an opened state. If outputs from both the second Hall sensor 222 and the third Hall sensor 223 are simultaneously detected, the control section 110 will determine that the folder of the mobile terminal is turned 180° upside down in an opened state. The control section 110 controls the direction of a picture to be displayed on the display section 160 according to the output from the direction detecting section 170. The process of controlling the display direction of the display section 160 will be explained in more detail with reference to FIGS. 6 and 7.

FIG. 6 is a flow chart showing a process of displaying a picture on a mobile terminal according to the present invention. The process of displaying a picture on a mobile terminal having the direction detecting section 170 will be explained in detail with reference to FIG. 6.

Referring to FIG. 6, the control section 110 determines whether the mobile terminal is in the display mode at step 511. The display mode refers herein to a mode of displaying a picture on the display section 160 when the folder housing is opened and apart from the main housing. Generally, the first display area 161 displays the initial setting, while the second display area 163 displays the date and time of the day and the third display area 165 displays the receiving sensitivity and the amount of remaining battery power. In a camera mode, an image photographed by the camera module 140 is processed through the image processing section 150 and displayed in the first display area of the display section 160. In a data communication mode and particularly in a character data communication mode, the first to third display areas 161 to 165 are all used to display character data. When an image mail is received, the first display area 161 displays the received image signal. As stated above, the first display area 161 preferably displays an image in QCIF size.

At step 513, the control section 110 detects if an automatic display change mode is set in the display mode. The automatic display change mode refers to a mode of automatically controlling the direction of a picture displayed on the display section 160 according to a direction detecting signal output from the direction detecting section 170. If the automatic display change mode is not set, the control section 110 will display pictures only in a fixed direction (first direction, 0°), regardless of the output from the direction detecting section 170.

If the automatic display change mode is set, the control section 110 will determine whether a direction detecting signal has been output from the direction detecting section 170. When a direction detecting signal is output from the direction detecting section 170, the control section 110 detects the output at step 514 and reads the output direction detecting signal at step 515.

If there was no display mode at step 511 or there was no automatic display change mode at step 513, the method proceeds to step 523 where a required function is performed.

If no signal is output from the Hall sensors 221 to 224, the direction detecting section 170 will generate a first direction detecting signal at step 514. When the folder of the mobile terminal is closed as shown in FIG. 3A, the first and fourth Hall sensors 221 and 224 simultaneously detect the first and second magnets 201 and 202. However, if the folder of the mobile terminal is opened so that the first and fourth Hall sensors 221 and 224 cannot detect the first and second magnets 201 and 202, the direction detecting section 170 will generate the first direction detecting signal and the control section 110 will read the generated signal. Since the first direction detecting signal is generated when the folder of the mobile terminal is opened in an upright direction, pictures should be displayed in the upright direction. Therefore, at step 529, the control section 110 controls the display section 160 to display pictures in the upright direction. FIG. 3B shows a mobile terminal with its folder opened in the upright direction.

If the second Hall sensor 222 detects the first magnet 201, the direction detecting section 170 will generate a second direction detecting signal at step 514. Also, the control section 110 will read the generated second direction detecting signal at step 515. The generation of the second direction detecting signal indicates that the folder of the mobile terminal is turned 90° counter-clockwise in a closed state. In such a condition, the display section 160 initially displays a picture in a direction turned 90° clockwise. The picture should be turned 90° counter-clockwise to be seen in the upright direction to the eyes of the viewer. Accordingly, upon detecting the second direction detecting signal at step 519, the control section 110 turns the picture data applied to the display section 160 90° counter-clockwise to be seen in the upright direction at step 521. At step 529, the control section 110 controls the display section 160 to display the picture in a direction turned 90° counter-clockwise. Thus, the viewer can see the picture in the upright position even when the folder of the mobile terminal is turned 90°. FIG. 3D shows a mobile terminal with its folder turned 90° counter-clockwise in a closed state.

If the second Hall sensor 222 detects the first magnet 201 and at the same time the third Hall sensor 223 detects the second magnet 202, the direction detecting section 170 will generate a third direction detecting signal at step 514. Also, the control section 110 will read the generated third direction detecting signal at step 515. The generation of the third direction detecting signal indicates that the folder of the mobile terminal is turned 180°. In such a condition, the display section 160 initially displays a picture upside down. The picture should be turned 180° again to be seen in the upright direction. Accordingly, the control section 110 turns the picture data applied to the display section 160 180° to be seen in the upright direction at step 525. At step 529, the control section 110 controls the display section 160 to display the picture in a direction turned 180° again. Thus, the viewer can see the picture in the upright position even when the mobile terminal is turned 180° upside down. FIG. 3E shows a mobile terminal with its folder turned 180°.

If the first Hall sensor 221 detects the first magnet 201, the direction detecting section 170 will generate a fourth direction detecting signal at step 514. Also, the control section 110 will read the generated fourth direction detecting signal at step 515. The generation of the fourth direction detecting signal indicates that the folder of the mobile terminal is turned 270° clockwise. In such a condition, the display section 160 initially displays a picture in a direction turned by the same angle. The picture should be turned 270° counter-clockwise to be seen in the upright direction. Accordingly, upon detecting the fourth direction detecting signal at step 519, the control section 110 turns the picture data applied to the display section 160 270° counter-clockwise to be seen in the upright direction at step 527. At step 529, the control section 110 controls the display section 160 to display the picture in a direction turned 270° counter-clockwise. Thus, the viewer can see the picture in the upright position even when the mobile terminal is turned 270° clockwise. FIG. 3C shows a mobile terminal with its folder turned 270° clockwise.

As described above, the direction detecting section 170 detects the direction of the folder of the mobile terminal and then turns image data to be displayed on the display section 160 in the opposite direction so as to be seen in the upright direction. The viewer can always see pictures in the upright position, regardless of the direction of the folder of the mobile terminal. However, there may be a problem in displaying a particular size of pictures when the folder of the mobile terminal is turned in the second or fourth direction. A picture photographed by the camera module can be displayed normally in a QCIF size when the folder of the mobile terminal is opened upright or turned in the third direction. However, it is difficult to display the picture in QCIF size when the folder of the mobile terminal is turned in the second or fourth direction. In such a case, it is preferable to display the picture in a full size.

When the folder of the mobile terminal is opened upright or turned in the third direction, image data in a fixed size, such as QCIF size, is displayed only after control of the direction of the visual display. When the folder of the mobile terminal is turned in the second or fourth direction, it is preferable to adjust and regenerate the size of such image data and control the direction of the visual display.

FIG. 7 is a flow chart showing another process of controlling the display of a picture on a mobile terminal according to an embodiment of the present invention. It is assumed that picture data is controlled to be displayed in QCIF size in the first or third direction and in a full size in the second or fourth direction. The process of controlling the display of a picture on a mobile terminal having the direction detecting section 170 will be described in detail with reference to FIG. 7.

Referring to FIG. 7, the control section 110 determines whether the mobile terminal is in the display mode at step 611. The display mode refers herein to a mode of displaying a picture on the display section 160 when the folder housing is opened and apart from the main housing. The display mode in FIG. 7 is the same as that in FIG. 6. The control section 110 detects the display mode at step 611. Also, the control section 110 detects if an automatic display change mode is set in the display mode at step 612. The automatic display change mode is the same as that explained in FIG. 6.

If there was no display mode at step 611 or there was no automatic display change mode at step 612, the method proceeds to step 616 where a required function is performed.

If the automatic display change mode is set, the control section 110 will determine whether a direction detecting signal has been output from the direction detecting section 170. When a direction detecting signal is output from the direction detecting section 170, the control section 110 detects the output at step 613 and reads the output direction detecting signal at step 614.

If no signal is output from the Hall sensors 221 to 224, the direction detecting section 170 will generate a first direction detecting signal at step 613. When the folder of the mobile terminal is closed as shown in FIG. 3A, the first and fourth Hall sensors 221 and 224 simultaneously detect the first and second magnets 201 and 202. However, if the folder of the mobile terminal is opened so that the first and fourth Hall sensors 221 and 224 cannot detect the first and second magnets 201 and 202, the direction detecting section 170 will generate data in QCIF size as first picture data at step 617. At step 625, the control section 110 controls the display section 160 to display the QCIF picture in the upright direction.

If the second Hall sensor 222 detects the first magnet 201, the direction detecting section 170 will generate a second direction detecting signal at step 613. Also, the control section 110 will read the generated second direction detecting signal at step 614. The generation of the second direction detecting signal indicates that the folder of the mobile terminal is turned 90° counter-clockwise in a closed state. In such a condition, the display section 160 initially displays a picture in a direction turned 90° clockwise. The picture should be turned 90° counter-clockwise to be seen in the upright direction to the eyes of the viewer. Also, the display section 160 should generate second picture data to display a full size picture, rather than a QCIF size picture. Upon detecting the second direction detecting signal at step 618, the control section 110 controls the display section 160 to generate the second picture data in a full size at step 619. At step 620, the control section 110 turns the second picture data 90° counter-clockwise to be seen in the upright direction. At step 625, the control section 110 controls the display section 160 to display the second picture data in a direction turned 90° counter-clockwise. Thus, the viewer can see the picture in the upright position even when the folder of the mobile terminal is turned 90°.

If the second Hall sensor 222 detects the first magnet 201 and at the same time the third Hall sensor 223 detects the second magnet 202, the direction detecting section 170 will generate a third direction detecting signal at step 613. Also, the control section 110 will read the generated third direction detecting signal at step 614. The generation of the third direction detecting signal indicates that the folder of the mobile terminal is turned 180° in an opened state. In such a condition, the display section 160 initially displays a picture upside down. The picture should be turned 180° again to be seen in the upright direction. Accordingly, upon detecting the third direction detecting signal at step 613, the control section 110 generates first picture data in QCIF size at step 623. At step 624, the control section 110 turns the first picture data applied to the display section 160 180° to be seen in the upright direction. At step 625, the control section 110 controls the display section 160 to display the first picture data in a direction turned 180° again. Thus, the viewer can see the picture in the upright position even when the mobile terminal is turned 180° upside down.

If the first Hall sensor 221 detects the first magnet 201, the direction detecting section 170 will generate a fourth direction detecting signal at step 613. Also, the control section 110 will read the generated fourth direction detecting signal at step 614. The generation of the fourth direction detecting signal indicates that the folder of the mobile terminal is turned 270° clockwise in an opened state. In such a condition, the display section 160 initially displays a picture in a direction turned by the same angle. The picture should be turned 270° counter-clockwise to be seen in the upright direction. Also, the display section 160 should generate second picture data to display a full size picture, rather than a QCIF size picture. Upon detecting the second direction detecting signal at step 618, the control section 110 controls the display section 160 to generate the second picture data in a full size at step 621. At step 622, the control section 110 turns the second picture data 270° counter-clockwise to be seen in the upright direction. At step 625, the control section 110 controls the display section 160 to display the second picture data in a direction turned 270° counter-clockwise. Thus, the viewer can see the picture in the upright position even when the mobile terminal is turned 270° clockwise.

A mobile terminal capable of controlling image data according to the procedure as shown in FIG. 7 can have the structure as shown in FIG. 1. In other words, a mobile terminal having a general communication function, including character data communication, can implement the process as shown in FIG. 6 by controlling the direction of the visual display of data according to the direction of the mobile terminal, without the need to adjust the size of the data. A mobile terminal with a built-in camera displays a picture photographed by the camera (camera module 140) in a fixed size which is suitable to be displayed in the first direction. When the picture is displayed in the second or fourth direction, its size should preferably be adjusted.

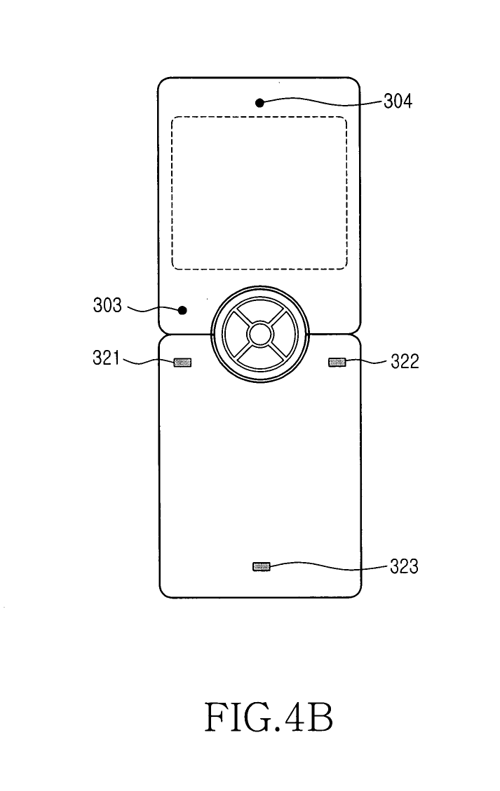

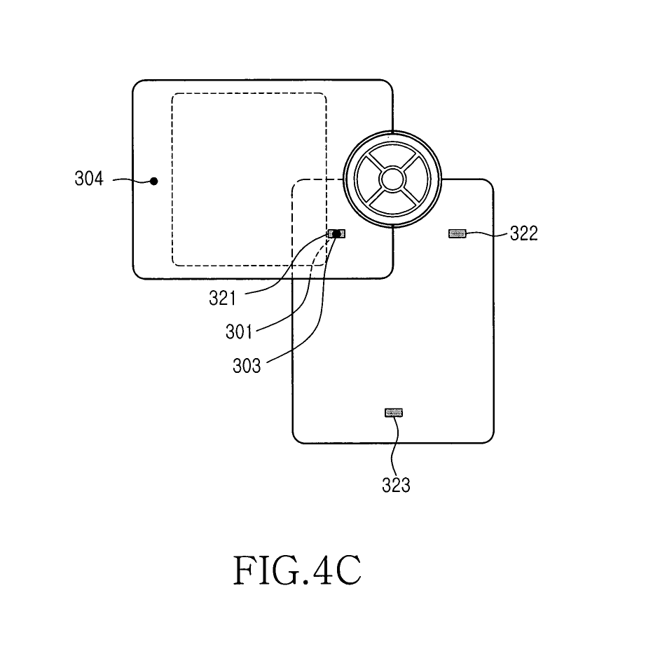

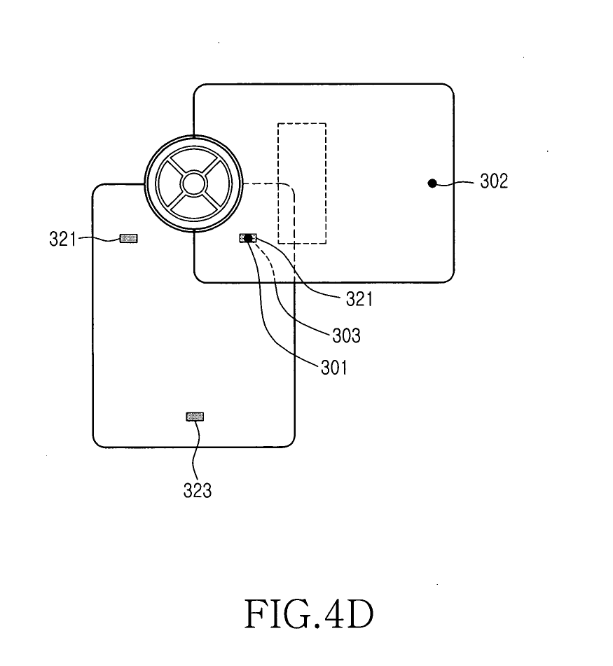

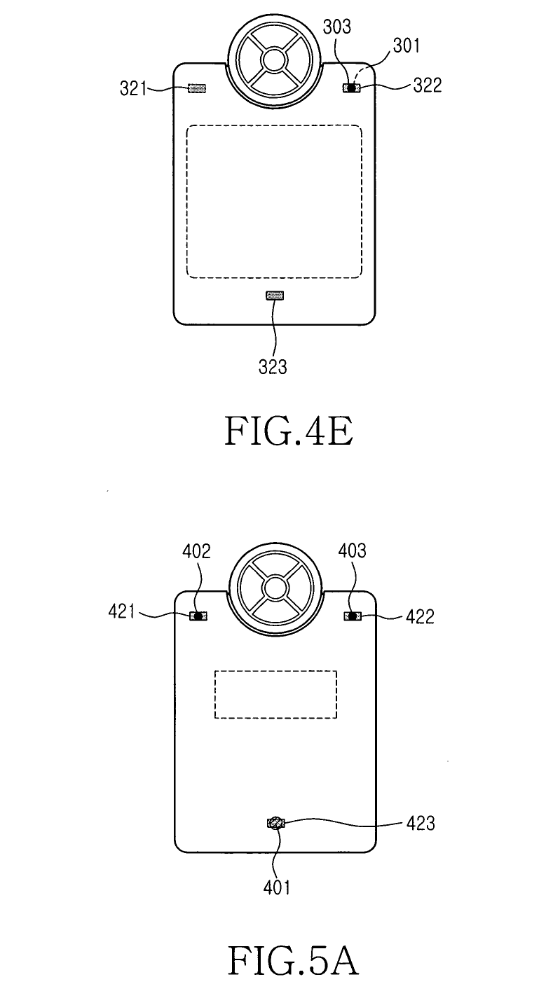

FIGS. 4A through 4E are block diagrams illustrating an operation of the direction detecting section 170 according to the second embodiment of the present invention. In the second embodiment, the mobile terminal has three direction sensors in the main housing and four fixed projections in the folder housing. The three direction sensors detect four directions in which the display section 160 can be placed. Two of the four projections are provided on the inner side of the folder that faces the key input section 127, while the other two projections are provided on the outer side of the folder. It is assumed that the direction sensors are Hall sensors (Hall effect ICs). The positions and numbers of the sensors and the projections may vary depending on the types of mobile terminals.

Referring to FIGS. 4A through 4E, the direction detecting section 170 comprises four projections 301, 302, 303 and 304 fixed on the folder of the mobile terminal and three Hall sensors 321, 322 and 323 mounted in the main housing to detect the projections 301 to 304 and generate a direction detecting signal. However, there is no limitation in the positions of the projections and the sensors. It is also possible to mount the projections in the main housing and the sensors in the folder. In the second embodiment of the invention, third and fourth projections 303 and 304 are provided on the inner side of the folder that faces the key input section 127, while first and second projections 301 and 302 are provided on the outer side of the folder. For explanatory convenience, it is assumed that the folders in FIGS. 4B through 4E are turned respectively in a first direction (turned 0° in an opened state), a fourth direction (turned 270° clockwise in an opened state), a second direction (turned 90° counter-clockwise in a closed state) and a third direction (turned 180° in an opened state).

When the second and third Hall sensors 322 and 323 simultaneously detect the first and second projections 301 and 302 as shown in FIG. 4E, the direction detecting section 170 generates a third direction detecting signal. When the second Hall sensor 322 detects the third projection 303 as shown in FIG. 4C, the direction detecting section 170 generates a second direction detecting signal. When the first Hall sensor 321 detects the first projection 301, the direction detecting section 170 generates a fourth direction detecting signal. Also, when the folder of the mobile terminal is closed as shown in FIG. 4A, the first Hall sensor detects the second projection 303 and at the same time the third Hall sensor 323 detects the fourth projection 304. When the folder of the mobile terminal is opened as shown in FIG. 4B so that the first and third Hall sensors 321 and 323 cannot detect the third and fourth projections 303 and 304, the direction detecting section 170 generates a first direction detecting signal. The first direction detecting signal is also generated when none of the Hall sensors 321 to 323 outputs a direction detecting signal.

The operation of a mobile terminal having the structure as shown in FIG. 1 will be explained in more detail with reference to FIGS. 2 to 4. When the folder housing is opened and apart from the main housing, the control section 110 controls the display section 160 to be in the display mode. The “display mode” includes both a communication mode and a mode for displaying image signals photographed by the camera module 140.

In the display mode, the first to third Hall sensors 321 to 323 of the direction detecting section 170 detect the projections 301 to 304 fixed on the folder of the mobile terminal. The control section 110 reads the output from the direction detecting section 170 to determine the positional state (direction) of the folder of the mobile terminal. If outputs from the second and third Hall sensors 322 and 323 are simultaneously detected, the control section 110 will determine that the folder of the mobile terminal is turned 180° upside down in an opened state. If an output from the second Hall sensor 322 is detected, the control section 110 will determine that the folder of the mobile terminal is turned 90° counter-clockwise in a closed state. If an output from the first Hall sensor 321 is detected, the control section 110 will determine that the folder of the mobile terminal is turned 270° clockwise in an opened state. Also, if no output from the Hall sensors 321 to 323 is detected, the control section 110 will determine that the folder of the mobile terminal is turned 0° and opened in a normal upright direction. The control section 110 controls the direction of a picture to be displayed on the display section 160 according to the output from the direction detecting section 170. The process of controlling the display direction of the display section 160 has been explained with reference to FIGS. 6 and 7.

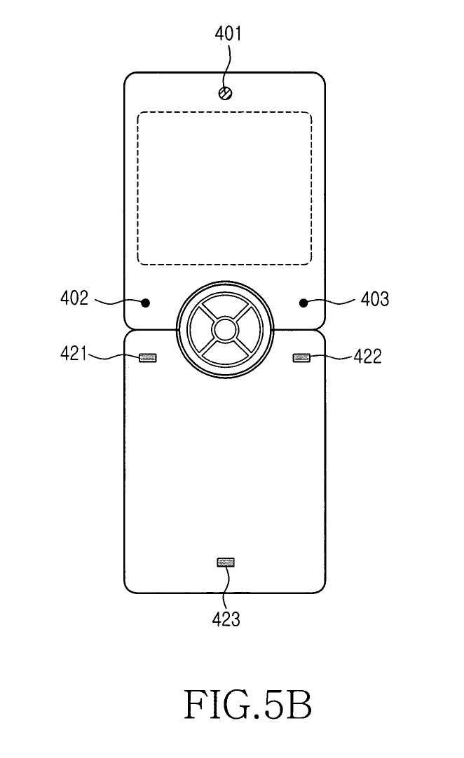

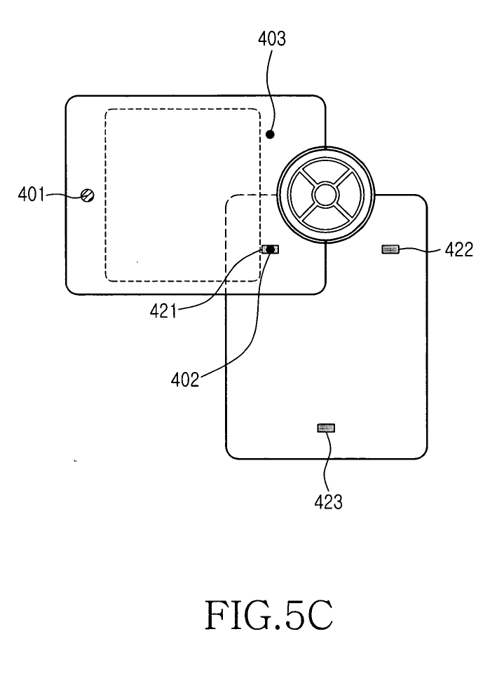

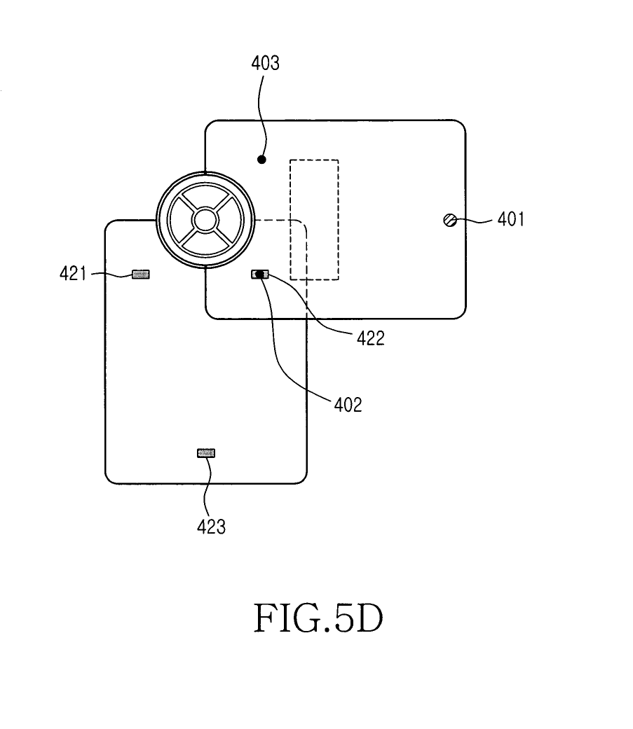

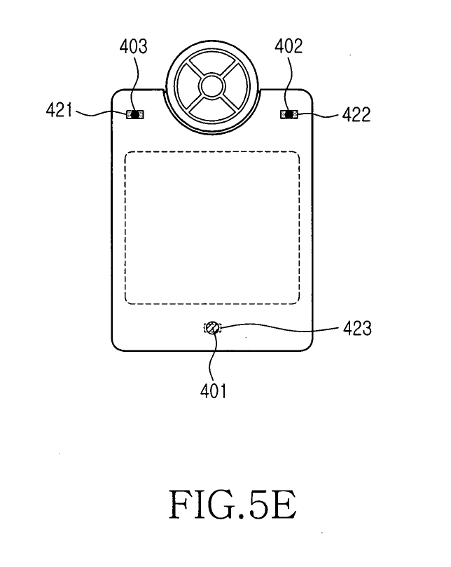

FIGS. 5A through to 5E are block diagrams illustrating an operation of the direction detecting section 170 according to a third embodiment of the present invention. In the third embodiment, the mobile terminal has three direction sensors in the main housing and one fixed projection and two magnets in the folder housing. The three direction sensors detect four directions in which the display section 160 can be placed. The projection is provided on the inner side of the folder that faces the key input section 127. It is assumed that the direction sensors are Hall sensors (Hall effect ICs). The positions and numbers of the sensors, projection and magnets may vary depending on the types of mobile terminals.

Referring to FIGS. 5A through 5e, the direction detecting section 170 comprises one projection 401 and two magnets 402 and 403 fixed on or within the folder housing and three Hall sensors 421 to 423 mounted in the main housing to detect the projection 401 or the magnets 402 and 403 and generate a direction detecting signal. However, there is no limitation on the positions of the projection, magnets and sensors. It is also possible to mount the projection and the magnets in the main housing and the sensors in the folder. For explanatory convenience, it is supposed that the folders in FIGS. 5B through 5E are turned respectively in a first direction (turned 0° in an opened state), a fourth direction (turned 270° clockwise in an opened state), a second direction (turned 90° counter-clockwise in a closed state) and a third direction (turned 180° in an opened state).

When the folder of the mobile terminal is closed as shown in FIG. 5A, the first and second Hall sensors 421 and 422 detect the first and second magnets 402 and 403 and at the same time the third Hall sensor 423 detects the projection 401. When the folder of the mobile terminal is opened as shown in FIG. 5B so that the three Hall sensors 421 to 423 cannot detect the projection 401 or the magnets 402 and 403, the direction detecting section 170 generates a first direction detecting signal. The first direction detecting signal is also generated when none of the Hall sensors 421 to 423 outputs a direction detecting signal. When the second Hall sensor 422 detects the first magnet 402 as shown in FIG. 5D, the direction detecting section 170 generates a second direction detecting signal. When the first Hall sensor 421 detects the first magnet 402 as shown in FIG. 5C, the direction detecting signal 170 generates a fourth direction detecting signal. Also, when the first Hall sensors 421 detects the second magnet 403 and at the same time the second Hall sensor 422 detects the first magnet 402 as shown in FIG. 5E, the direction detecting signal generates a third direction detecting signal.

The operation of a mobile terminal having the structure as shown in FIG. 1 will be explained in more detail with reference to FIGS. 2 to 5. When the folder housing is opened and apart from the main housing, the control section 110 controls the display section 160 to be in the display mode. The “display mode” includes both a communication mode and a mode for displaying image signals photographed by the camera module 140.

In the display mode, the first to third Hall sensors 421 to 423 of the direction detecting section 170 detect the fixed projection 401 and the magnets 402 and 403 according to the direction in which the folder of the mobile terminal is placed. The control section 110 reads the output from the direction detecting section 170 to determine the positional state (direction) of the folder of the mobile terminal.

If no output from the Hall sensors 421 to 423 is detected, the control section 110 will determine that the folder of the mobile terminal is turned 0° and opened in a normal upright direction. If an output from the second Hall sensor 422 is detected, the control section 110 will determine that the folder of the mobile terminal is turned 90° counter-clockwise in a closed state. If an output from the first Hall sensor 421 is detected, the control section 110 will determine that the folder of the mobile terminal is turned 270° clockwise in an opened state. Also, if outputs from the first and second Hall sensors 322 and 323 are simultaneously detected, the control section 110 will determine that the folder of the mobile terminal is turned 180° upside down in an opened state. The control section 110 controls the direction of a picture to be displayed on the display section 160 according to the output from the direction detecting section 170. The process of controlling the display direction of the display section 160 has been explained with reference to FIGS. 6 and 7.

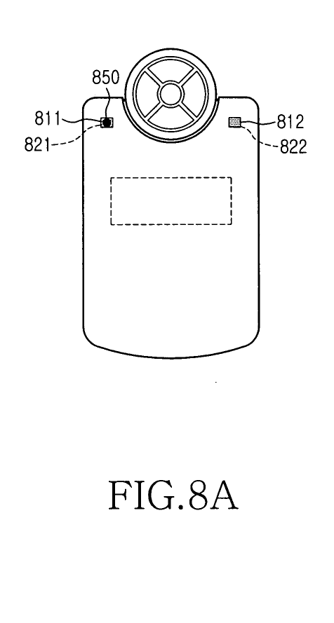

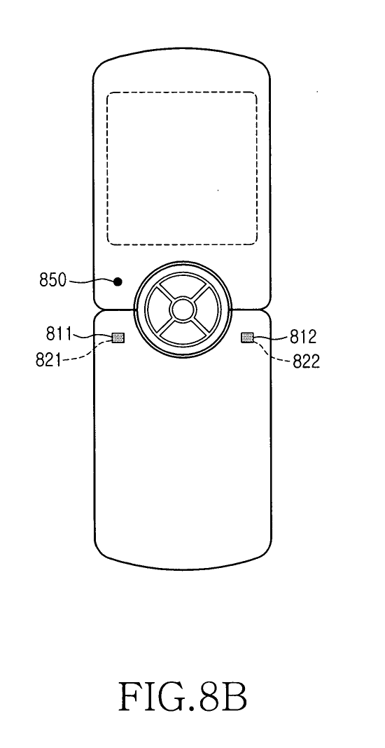

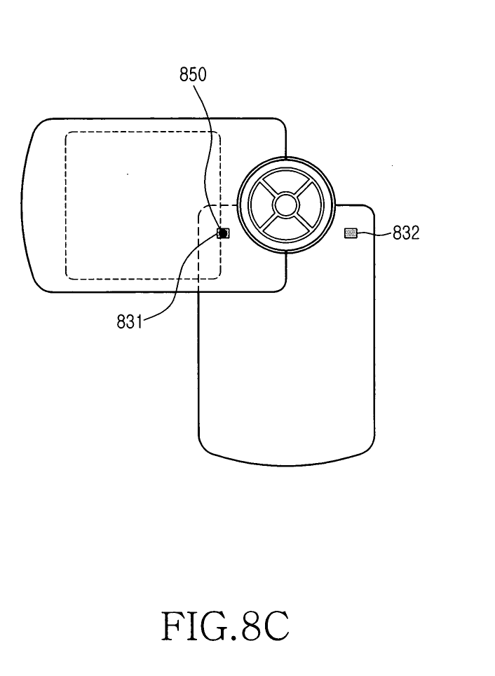

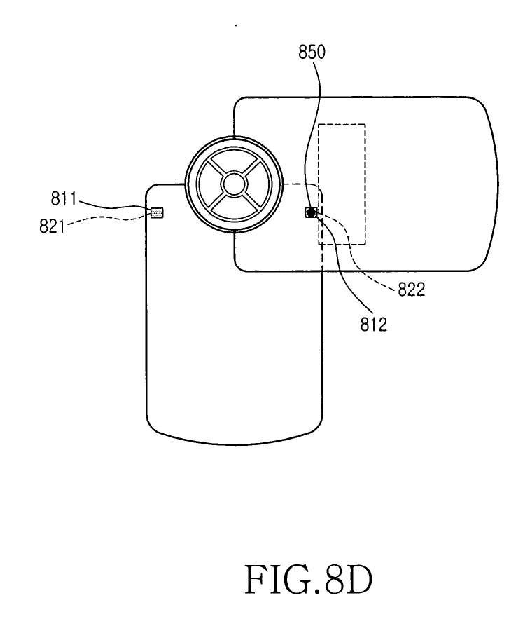

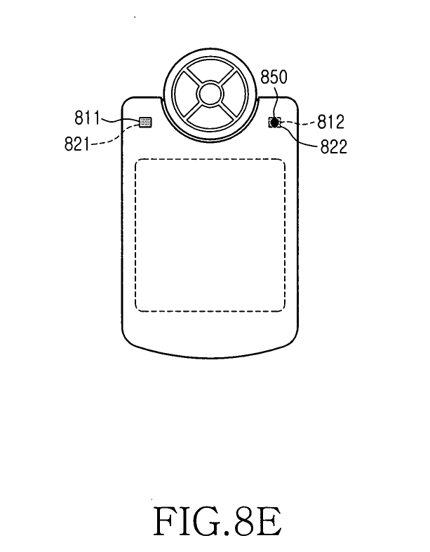

FIGS. 8A through 8E are block diagrams illustrating an operation of the direction detecting section 170 according to a fourth embodiment of the present invention. In the fourth embodiment, the mobile terminal has four direction sensors in the main housing and one magnet fixed within the folder housing. The four sensors detect four directions in which the display section 160 can be placed according to the detected pole (N pole or S pole) of the magnet. It is assumed that the direction sensors used in the fourth embodiment are Hall sensors (Hall effect ICs). The positions and numbers of the sensors and the magnet may vary depending on the types of mobile terminals.

Referring to FIGS. 8A through 8E, the direction detecting section 170 comprises one magnet 850 fixed within the folder housing and four Hall sensors 811, 812, 821 and 822 mounted in the main housing to detect the polarity of the magnet 850 and generate a direction detecting signal. In the fourth embodiment as shown in FIGS. 8A through 8E, two Hall sensors 811 and 812 are used to detect the N pole of the magnet and mounted on the front side of the Printed Circuit Board (PCB) of the main housing that contacts the folder housing of the mobile terminal. Also, the other two Hall sensors 821 and 822 are used to detect the S pole of the magnet and mounted on the rear side of the PCB of the main housing. However, it is also possible to use the Hall sensors 811 and 812 mounted on the front side of the PCB to detect the S pole of the magnet and the Hall sensors 821 and 822 mounted on the rear side of the PCB to detect the N pole of the magnet.

There is no limitation in the positions of the magnet and the sensors. It is also possible to mount the magnet in the main housing and the sensors in the folder. For explanatory convenience, it is assumed that the folders in FIGS. 8B through 8E are turned respectively in a first direction (turned 0° in an opened state), a fourth direction (turned 270° clockwise in an opened state), a second direction (turned 90° counter-clockwise in a closed state) and a third direction (turned 180° in an opened state).

When the folder of the mobile terminal is closed as shown in FIG. 8A, the first Hall sensor 811 detects the N pole of the magnet 850. When the folder of the mobile terminal is opened as shown in FIG. 8B so that none of the four Hall sensors 811, 812, 821 and 822 can detect the polarity of the magnet 850, the direction detecting section 170 generates a first direction detecting signal. The first direction detecting signal is also generated when none of the Hall sensors 811, 812, 821 and 822 outputs a direction detecting signal. When the second Hall sensor 812 detects the N pole of the magnet 850 as shown in FIG. 8D, the direction detecting section 170 generates a second direction detecting signal. When the third Hall sensor 821 detects the S pole of the magnet 850 as shown in FIG. 8C, the direction detecting signal 170 generates a fourth direction detecting signal. Also, when the fourth Hall sensors 822 detects the S pole of the magnet 850 as shown in FIG. 8E, the direction detecting signal generates a third direction detecting signal.

The operation of a mobile terminal having the structure as shown in FIG. 1 will be explained in more detail with reference to FIGS. 2 and 3. When the folder housing is opened and apart from the main housing, the control section 110 controls the display section 160 to be in the display mode. The “display mode” includes both a communication mode and a mode for displaying image signals photographed by the camera module 140.

In the display mode, the first to fourth Hall sensors 811, 812, 821 and 822 of the direction detecting section 170 detect the polarity (N pole or S pole) of the fixed magnet 850 according to the direction in which the folder of the mobile terminal is placed. The control section 110 reads the output from the direction detecting section 170 to determine the positional state (direction) of the folder of the mobile terminal.

If no output from the Hall sensors 811, 812, 821 and 822 is detected, the control section 110 will determine that the folder of the mobile terminal is turned 0° and opened in a normal upright direction. If an output from the second Hall sensor 812 is detected, the control section 110 will determine that the folder of the mobile terminal is turned 90° counter-clockwise in a closed state. If an output from the third Hall sensor 821 is detected, the control section 110 will determine that the folder of the mobile terminal is turned 270° clockwise in an opened state. Also, if an output from the fourth Hall sensor 822 is detected, the control section 110 will determine that the folder of the mobile terminal is turned 180° upside down in an opened state. The control section 110 controls the direction of a picture to be displayed on the display section 160 according to the output from the direction detecting section 170. The process of controlling the display direction of the display section 160 has been explained with reference to FIGS. 6 and 7.

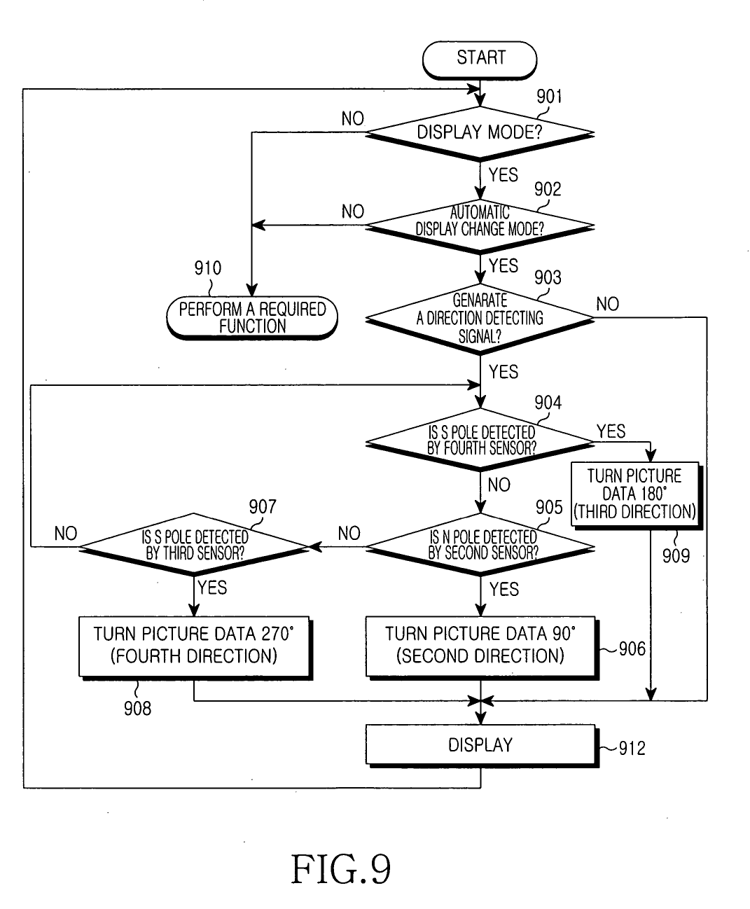

FIG. 9 is a flow chart showing a process of displaying a picture on a mobile terminal according to the fourth embodiment of the present invention. The process of displaying a picture on a mobile terminal having the direction detecting section 170 as shown in FIGS. 8A through 8E will be explained in detail with reference to FIG. 9.

Referring to FIG. 9, the control section 110 determines whether the mobile terminal is in the display mode at step 901. Also, the control section 110 detects whether an automatic display change mode is set in the display mode at step 902. The automatic display change mode refers to a mode of automatically controlling the direction of a picture displayed on the display section 160 according to a direction detecting signal output from the direction detecting section 170. If the automatic display change mode is not set, the control section 110 will display pictures only in a fixed direction (first direction, 0°), regardless of the output from the direction detecting section 170. If the automatic display change mode is set, the control section 110 will determine whether a direction detecting signal has been output from the direction detecting section 170. When a direction detecting signal is output from the direction detecting section 170, the control section 110 detects the output and reads the output direction detecting signal at step 903.

If there was no display mode at step 901 or there was no automatic display change mode at step 902, the method proceeds to step 910 where a required function is performed.

If no signal is output from the Hall sensors 811, 812, 821 and 822, the direction detecting section 170 will generate a first direction detecting signal at step 903. When the folder of the mobile terminal is closed as shown in FIG. 8a, the first Hall sensor 811 detects the N pole of the magnet 850. However, if the folder of the mobile terminal is opened so that none of the Hall sensors 811, 812, 821 and 822 can detect the polarity of the magnet 850, the direction detecting section 170 will generate the first direction detecting signal and the control section 110 will read the generated signal. Since the first direction detecting signal is generated when the folder of the mobile terminal is placed in an upright direction, pictures should be displayed in the upright direction. Therefore, at step 912, the control section 110 controls the display section 160 to display pictures in the upright direction. FIG. 8B shows a mobile terminal with its folder opened in the upright direction.

If the second Hall sensor 812 detects the N pole of the magnet 850, the direction detecting section 170 will generate a second direction detecting signal at step 905. Also, the control section 110 will read the generated second direction detecting signal. The generation of the second direction detecting signal indicates that the folder of the mobile terminal is turned 90° counter-clockwise in a closed state. In such a condition, the display section 160 initially displays a picture in a direction turned 90° clockwise. The picture should be turned 90° counter-clockwise to be seen in the upright direction to the eyes of the viewer. Accordingly, the control section 110 turns the picture data applied to the display section 160 90° counter-clockwise to be seen in the upright direction at step 906. At step 912, the control section 110 controls the display section 160 to display the picture in a direction turned 90° counter-clockwise. Thus, the viewer can see the picture in the upright position even when the folder of the mobile terminal is turned 90°. FIG. 8D shows a mobile terminal with its folder turned 90° counter-clockwise in a closed state.

If the fourth Hall sensor 822 detects the S pole of the magnet 850, the direction detecting section 170 will generate a third direction detecting signal at step 904. Also, the control section 110 will read the generated third direction detecting signal. The generation of the third direction detecting signal indicates that the folder of the mobile terminal is turned 180°. In such a condition, the display section 160 initially displays a picture upside down. The picture should be turned 180° again to be seen in the upright direction. Accordingly, the control section 110 turns the picture data applied to the display section 160 180° again to be seen in the upright direction at step 909. At step 912, the control section 110 controls the display section 160 to display the picture in a direction turned 180° again. Thus, the viewer can see the picture in the upright position even when the mobile terminal is turned 180° upside down. FIG. 8E shows a mobile terminal with its folder turned 180°.

If the third Hall sensor 821 detects the S pole of the magnet 850, the direction detecting section 170 will generate a fourth direction detecting signal at step 907. Also, the control section 110 will read the generated fourth direction detecting signal. The generation of the fourth direction detecting signal indicates that the folder of the mobile terminal is turned 270° clockwise. In such a condition, the display section 160 initially displays a picture in a direction turned by the same angle. The picture should be turned 270° counter-clockwise to be seen in the upright direction. Accordingly, the control section 110 turns the picture data applied to the display section 160 270° counter-clockwise to be seen in the upright direction at step 908. At step 912, the control section 110 controls the display section 160 to display the picture in a direction turned 270° counter-clockwise. Thus, the viewer can see the picture in the upright position even when the mobile terminal is turned 270° clockwise. FIG. 8C shows a mobile terminal with its folder turned 270° clockwise.

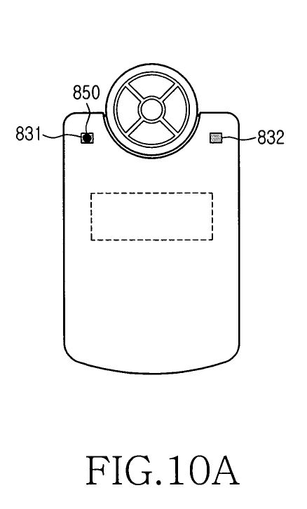

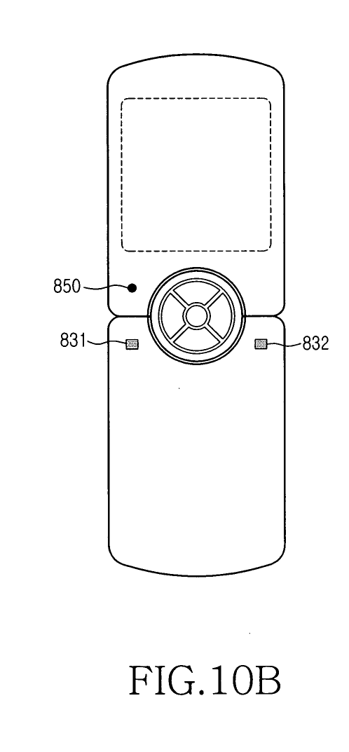

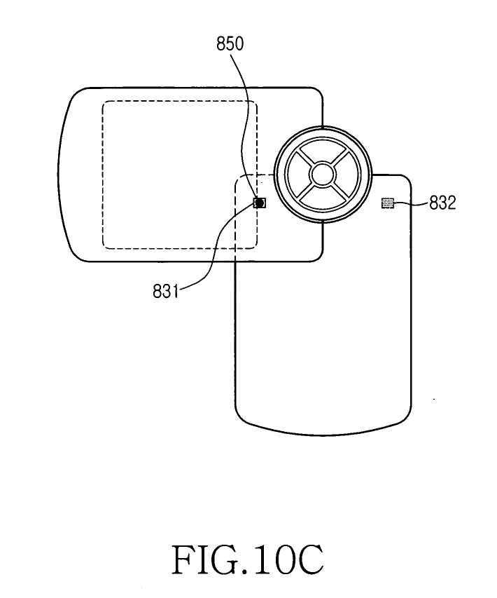

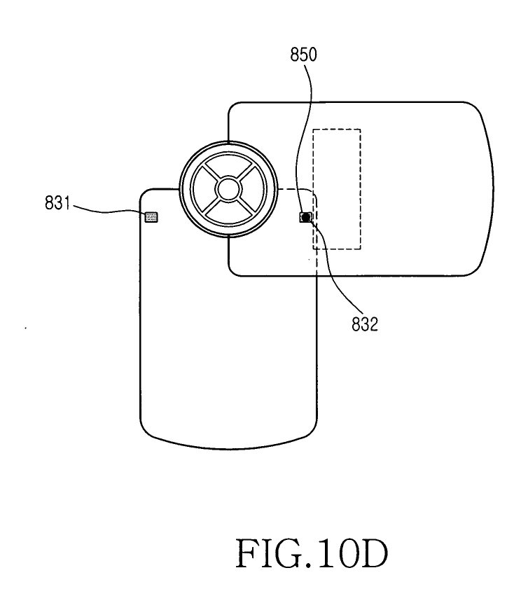

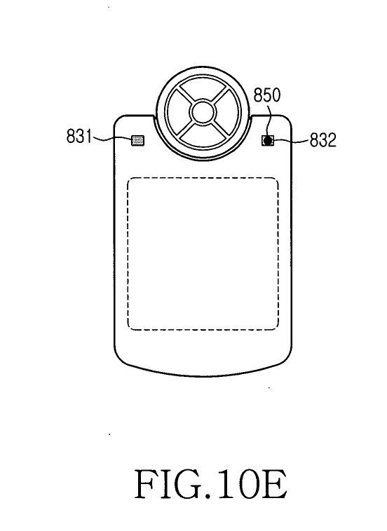

FIGS. 10A through 10E are block diagrams illustrating an operation of the direction detecting section 170 according to a fifth embodiment of the present invention. In the fifth embodiment, the mobile terminal has two direction sensors in the main housing and one fixed magnet in the folder housing. The two sensors detect four directions in which the display section 160 can be placed according to the detected pole (N pole or S pole) of the magnet. It is assumed that the direction sensors used in the fifth embodiment are Hall sensors (Hall effect ICs). The positions and numbers of the sensors and the magnet may vary depending on the types of mobile terminals.

Referring to FIGS. 10A through 10E, the direction detecting section 170 comprises one magnet 850 fixed within the folder housing and two Hall sensors 831 and 832 mounted in the main housing to detect the polarity of the magnet 850 and generate a direction detecting signal. In the fifth embodiment as shown in FIGS. 10A through 10E, the magnet 850 can be mounted in the folder in such a manner that the N pole faces the main housing. In this case, the direction detecting section 170 generates a second direction detecting signal when the second Hall sensor 832 detects the N pole of the magnet 850, a third direction detecting signal when the second Hall sensor 832 detects the S pole of the magnet 850 and a fourth direction detecting signal when the first Hall sensor 831 detects the S pole of the magnet 850. Also, the first Hall sensor 831 detects the N pole of the magnet 850 when the folder of the mobile terminal is closed. Alternatively, the magnet 850 can be mounted to have the S pole face the main housing. In the latter case, the direction detecting section 170 generates the second direction detecting signal when the second Hall sensor 832 detects the S pole of the magnet 850, the third direction detecting signal when the second Hall sensor 832 detects the N pole of the magnet 850 and the fourth direction detecting signal when the first Hall sensor 831 detects the N pole of the magnet 850. Also, the first Hall sensor 831 detects the S pole of the magnet 850 when the folder of the mobile terminal is closed. Although the two Hall sensors 831 and 832 are assumed to be mounted on the front side of the PCB of the main housing in the fifth embodiment, they can be mounted on the rear side of the PCB.

There is no limitation in the positions of the magnet and the sensors. It is also possible to mount the magnet in the main housing and the sensors in the folder. For explanatory convenience, it is supposed that the folders in FIGS. 10B through 10E are turned respectively in a first direction (turned 0° in an opened state), a fourth direction (turned 270° clockwise in an opened state), a second direction (turned 90° counter-clockwise in a closed state) and a third direction (turned 180° in an opened state).

When the folder of the mobile terminal is closed as shown in FIG. 10A, the first Hall sensor 831 detects the N pole of the magnet 850. When the folder of the mobile terminal is opened as shown in FIG. 10B so that none of the two Hall sensors 831 and 832 can detect the polarity of the magnet 850, the direction detecting section 170 generates the first direction detecting signal. The first direction detecting signal is also generated when none of the Hall sensors 831 and 832 outputs a direction detecting signal.

When the second Hall sensor 832 detects the N pole of the magnet 850 as shown in FIG. 10D, the direction detecting section 170 generates the second direction detecting signal. When the second Hall sensor 832 detects the S pole of the magnet 850 as shown in FIG. 10E, the direction detecting signal 170 generates the third direction detecting signal. Also, when the first Hall sensor 821 detects the S pole of the magnet 850 as shown in FIG. 10C, the direction detecting signal generates the fourth direction detecting signal.

The operation of a mobile terminal having the structure as shown in FIG. 1 will be explained in more detail with reference to FIGS. 2 and 10. When the folder housing is opened and apart from the main housing, the control section 110 controls the display section 160 to be in the display mode. The “display mode” includes both a communication mode and a mode for displaying image signals photographed by the camera module 140.

In the display mode, the first and second Hall sensors 831 and 832 of the direction detecting section 170 detect the polarity (N pole or S pole) of the fixed magnet 850 according to the direction in which the folder of the mobile terminal is placed. The control section 110 reads the output from the direction detecting section 170 to determine the positional state (direction) of the folder of the mobile terminal.

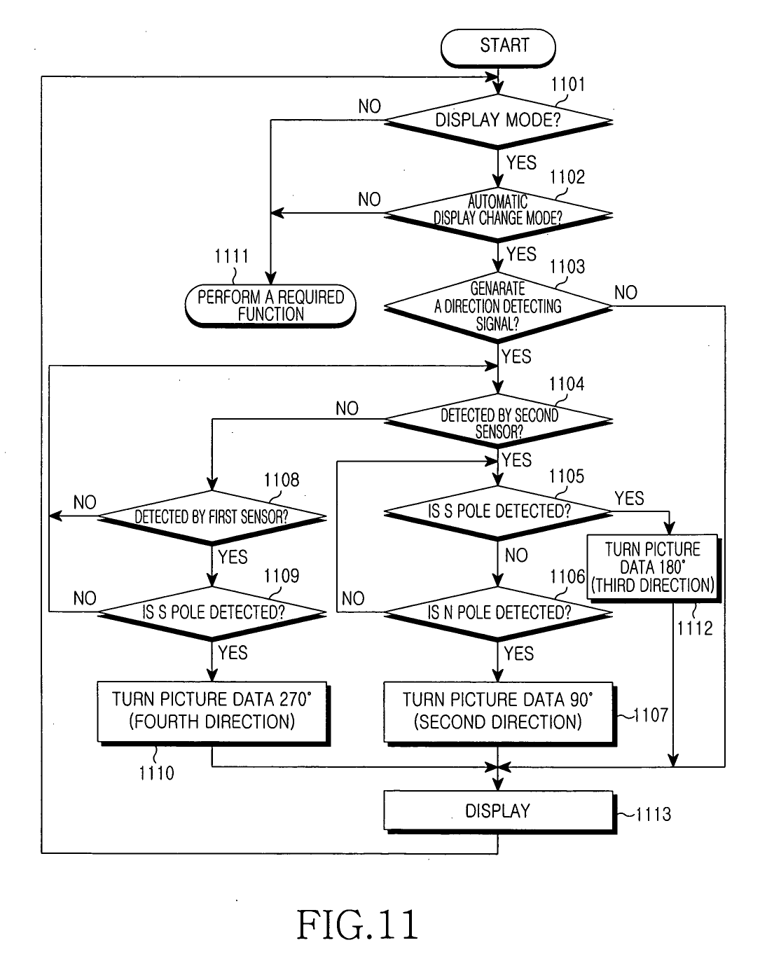

If no output from the Hall sensors 831 and 832 is detected, the control section 110 will determine that the folder of the mobile terminal is turned 0° and opened in a normal upright direction. If an N pole detecting output from the second Hall sensor 832 is detected, the control section 110 will determine that the folder of the mobile terminal is turned 90° counter-clockwise in a closed state. If an S pole detecting output from the first Hall sensor 831 is detected, the control section 110 will determine that the folder of the mobile terminal is turned 270° clockwise in an opened state. Also, if an S pole detecting output from the second Hall sensor 832 is detected, the control section 110 will determine that the folder of the mobile terminal is turned 180° upside down in an opened state. The control section 110 controls the direction of a picture to be displayed on the display section 160 according to the output from the direction detecting section 170. The process of controlling the display direction of the display section 160 will be explained in detail with reference to FIG. 11.

FIG. 11 is a flow chart showing a process of displaying a picture on a mobile terminal according to the fifth embodiment of the present invention. The process of displaying a picture on a mobile terminal having the direction detecting section 170 as shown in FIGS. 10A through 10E will be explained in detail with reference to FIG. 11.

Referring to FIG. 11, the control section 110 determines whether the mobile terminal is in the display mode at step 1101. The display mode refers herein to a mode of displaying a picture on the display section 160 when the folder housing is opened and apart from the main housing.

The control section 110 detects if an automatic display change mode is set in the display mode at step 1102. The automatic display change mode refers to a mode of automatically controlling the direction of a picture displayed on the display section 160 according to a direction detecting signal output from the direction detecting section 170. If the automatic display change mode is not set, the control section 110 will display pictures only in a fixed direction (first direction, 0°), regardless of the output from the direction detecting section 170. If the automatic display change mode is set, the control section 110 will determine whether a direction detecting signal has been output from the direction detecting section 170. When a direction detecting signal is output from the direction detecting section 170, the control section 110 detects the output and reads the output direction detecting signal at step 1103.

If there was no display mode at step 1101 or there was no automatic display change mode at step 1102, the method proceeds to step 1111 where a required function is performed.

If no signal is output from the Hall sensors 831 and 832, the direction detecting section 170 will generate a first direction detecting signal at step 1103. When the folder of the mobile terminal is closed as shown in FIG. 10A, the first Hall sensor 831 detects the N pole of the magnet 850. However, if the folder of the mobile terminal is opened so that the first Hall sensor 831 cannot detect the N pole of the magnet 850, the direction detecting section 170 will generate the first direction detecting signal and the control section 110 will read the generated signal. Since the first direction detecting signal is generated when the folder of the mobile terminal is opened in an upright direction, pictures should be displayed in the upright direction. Therefore, the control section 110 controls the display section 160 to display pictures in the upright direction at step 1113. FIG. 10B shows a mobile terminal with its folder opened in the upright direction.

If the second Hall sensor 832 detects the N pole of the magnet 850, the direction detecting section 170 will detect the output from the second Hall sensor 832 and generate a second direction detecting signal at steps 1104 and 1106. Also, the control section 110 will read the generated second direction detecting signal. The generation of the second direction detecting signal indicates that the folder of the mobile terminal is turned 90° counter-clockwise in a closed state. In such a condition, the display section 160 initially displays a picture in a direction turned 90° clockwise. The picture should be turned 90° counter-clockwise to be seen in the upright direction to the eyes of the viewer. Accordingly, the control section 110 turns the picture data applied to the display section 160 90° counter-clockwise to be seen in the upright direction at step 1107. At step 1113, the control section 110 controls the display section 160 to display the picture in a direction turned 90° counter-clockwise. Thus, the viewer can see the picture in the upright position even when the folder of the mobile terminal is turned 90°. FIG. 10D shows a mobile terminal with its folder turned 90° counter-clockwise in a closed state.

If the second Hall sensor 832 detects the S pole of the magnet 850, the direction detecting section 170 will detect the output from the second Hall sensor 832 and generate a third direction detecting signal at steps 1104 and 1105. Also, the control section 110 will read the generated third direction detecting signal. The generation of the third direction detecting signal indicates that the folder of the mobile terminal is turned 180°. In such a condition, the display section 160 initially displays a picture upside down. The picture should be turned 180° again to be seen in the upright direction. Accordingly, the control section 110 turns the picture data applied to the display section 160 180° again to be seen in the upright direction at step 1112. At step 1113, the control section 110 controls the display section 160 to display the picture in a direction turned 180° again. Thus, the viewer can see the picture in the upright position even when the mobile terminal is turned 180° upside down. FIG. 10E shows a mobile terminal with its folder turned 180°.

If the first Hall sensor 831 detects the S pole of the magnet 850, the direction detecting section 170 will detect the output from the first Hall sensor 831 and generate a fourth direction detecting signal at steps 1108 and 1109. Also, the control section 110 will read the generated fourth direction detecting signal. The generation of the fourth direction detecting signal indicates that the folder of the mobile terminal is turned 270° clockwise. In such a condition, the display section 160 initially displays a picture in a direction turned by the same angle. The picture should be turned 270° counter-clockwise to be seen in the upright direction. Accordingly, the control section 110 turns the picture data applied to the display section 160 270° counter-clockwise to be seen in the upright direction at step 1110. At step 1113, the control section 110 controls the display section 160 to display the picture in a direction turned 270° counter-clockwise. Thus, the viewer can see the picture in the upright position even when the mobile terminal is turned 270° clockwise. FIG. 10C shows a mobile terminal with its folder turned 270° clockwise.

As described with reference to FIGS. 8 to 11, the direction detecting section 170 detects the direction of the folder of the mobile terminal and then turns data to be displayed on the display section 160 in the opposite direction so as to be seen in the upright direction. The viewer can always see pictures in the upright position, regardless of the direction of the folder of the mobile terminal. However, there may be a problem in displaying a particular size of pictures when the folder of the mobile terminal is turned in the second or fourth direction. A picture photographed by the camera module can be normally displayed in QCIF size when the folder of the mobile terminal is opened upright or turned in the third direction. However, it is difficult to display the picture in QCIF size when the folder of the mobile terminal is turned in the second or fourth direction. Accordingly, when the folder of the mobile terminal is opened upright or turned in the third direction, image data is displayed only after control of the direction of the visual display. When the folder of the mobile terminal is turned in the second or fourth direction, it is preferable to regenerate the image data in an adjusted size and control the direction of the visual display.

Although embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

According to the embodiments of the present invention, the direction detecting section 170 detects the direction of the folder of the mobile terminal and turns data to be displayed in the opposite direction thereby to be seen in the upright direction. The viewer can always see pictures in the upright position, regardless of the direction of the folder of the mobile terminal.

What is claimed is:

1. A device for displaying a picture in a mobile terminal, which comprises:
a direction detecting section comprising at least one magnet fixed within the mobile terminal and a plurality of sensors for detecting the magnet in order to detect the direction in which the mobile terminal is turned and generating a first direction detecting signal, a second direction detecting signal, a third direction detecting signal, and a fourth direction detecting signal;
a control section for outputting picture data having an orientation based on the detected direction; and
a display section for displaying the picture data.

2. The device according to claim 1, wherein said control section outputs data in an upright direction when the first direction detecting, signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated.

3. The device according to claim 1, wherein said direction detecting section comprises:
first and second magnets fixed within the mobile terminal; and
a first sensor, a second sensor, a third sensor, and a fourth sensor for detecting the first and second magnets according to the direction in which the mobile terminal is turned and generating a corresponding direction detecting signal.

4. A device for displaying a picture in a mobile terminal, which comprises:
a camera module for photographing an image signal;
an image processing section for processing the image signal photographed by the camera module in a display picture size;
a direction detecting section comprising at least one magnet fixed within the mobile terminal and a plurality of sensors for detecting the magnet in order to detect the direction in which the mobile terminal is turned and generate a first direction detecting signal, a second direction detecting signal, a third direction detecting signal, and a fourth direction detecting signal;
a control section for outputting picture data having an orientation based on the detected direction; and
a display section for displaying the picture data.

5. The device according to claim 4, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated

6. A device for displaying a picture in a mobile terminal, which comprises:
a tuner for receiving a composite television video signal broadcast on a selected channel;
a decoder for decoding the composite video signal to generate an analog video signal and a synchronizing signal;
a video processing section for converting the analog video signal into a digital video data, processing the digital video data in a frame size and outputting a frame video signal and user data in the frame;
a direction detecting section comprising at least one magnet fixed within the mobile terminal and a plurality of sensors for detecting the magnet in order to detect the direction in which the mobile terminal is turned and generate a first direction detecting signal, a second direction detecting signal, a third direction detecting signal, and a fourth direction detecting signal;
a control section for outputting picture data having an orientation based on the detected direction; and
a display section for displaying the picture data.

7. The device according to claim 6, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated

8. A device for displaying a picture in a mobile terminal, which comprises:
a direction detecting section comprising at least one projection fixed on the mobile terminal and a plurality of sensors for detecting the projection in order to detect the direction in which the mobile terminal is turned and generate a first direction detecting signal, a second direction detecting signal, a third direction detecting signal, and a fourth direction detecting signal;
a control section for outputting picture data having an orientation based on the detected direction; and
a display section for displaying the picture data.

9. The device according to claim 8, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated.

10. The device according to claim 8, wherein said direction detecting section comprises:
a first projection, a second projection, a third projection, and a fourth projection fixed on the mobile terminal; and
a first sensor, a second sensor, and a third sensor for detecting the first projection, the second projection, the third projection and the fourth projection according to the direction in which the mobile terminal is turned and generating a corresponding direction detecting signal.

11. A device for displaying a picture in a mobile terminal, which comprises:
a camera module for photographing an image signal;
an image processing section for processing the image signal photographed by the camera module in a display picture size;
a direction detecting section comprising at least one projection fixed on the mobile terminal and a plurality of sensors for detecting the projection in order to detect the direction in which the mobile terminal is turned and generate a first direction detecting signal, a second direction detecting signal, a third direction detecting signal, and a fourth direction detecting signal;
a control section for outputting picture data having an orientation based on the detected direction; and
a display section for displaying the picture data.

12. The device according to claim 11, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated.

13. A device for displaying a picture in a mobile terminal, which comprises:
a tuner for receiving a composite television video signal broadcast on a selected channel;
a decoder for decoding the composite video signal to generate an analog video signal and a synchronizing signal;
a video processing section for converting the analog video signal into a digital video data, processing the digital video data into a frame size and outputting a frame video signal and user data in the frame;
a direction detecting section comprising at least one projection fixed on the mobile terminal and a plurality of sensors for detecting the projection in order to detect the direction in which the mobile terminal is turned and generate a first direction detecting signal, a second direction detecting signal, a third direction detecting signal, and a fourth direction detecting signals;
a control section for outputting picture data having an orientation based on the detected direction; and
a display section for displaying the picture data.

14. The device according to claim 13, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated.

15. A device for displaying a picture in a mobile terminal, which comprises:
a direction detecting section comprising at least one projection and at least one magnet fixed on or in the mobile terminal and a plurality of sensors for detecting the projection or the magnet in order to detect the direction in which the mobile terminal is turned and generate a first direction detecting signal, a second direction detecting signal, a third direction detecting signal, and a fourth direction detecting signals;
a control section for outputting picture data having an orientation based on the detected direction; and
a display section for displaying the picture data.

16. The device according to claim 15, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated.

17. The device according to claim 15, wherein said direction detecting section comprises:
one projection and first and second magnets fixed on or in the mobile terminal; and
a first sensor, a second sensor, and a third sensor for detecting the projection and the magnets according to the direction in which the mobile terminal is turned and generating a corresponding direction detecting signal.

18. A device for displaying a picture in a mobile terminal, which comprises:
a camera module for photographing an image signal;
an image processing section for processing the image signal photographed by the camera module in a display picture size;
a direction detecting section comprising at least one projection and at least one magnet fixed on or in the mobile terminal and a plurality of sensors for detecting the projection or the magnet in order to detect the direction in which the mobile terminal is turned and generate a first direction detecting signal, a second direction detecting signal, a third direction detecting signal, and a fourth direction detecting signal;
a control section for outputting picture data having an orientation based on the detected direction; and
a display section for displaying the picture data.

19. The device according to claim 18, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated.

20. A device for displaying a picture in a mobile terminal, which comprises:
a tuner for receiving a composite television video signal broadcast on a selected channel;
a decoder for decoding the composite video signal to generate an analog video signal and a synchronizing signal;
a video processing section for converting the analog video signal into a digital video data, processing the digital video data in a frame size and outputting a frame video signal and user data in the frame;
a direction detecting section comprising at least one projection or at least one magnet fixed on or in the mobile terminal and a plurality of sensors for detecting at least one of the projection and the magnet in order to detect the direction in which the mobile terminal is turned and generate a first direction detecting signal, a second direction detecting signal, a third direction detecting signal, and a fourth direction detecting signal;
a control section for outputting picture data having an orientation based on the detected direction; and
a display section for displaying the picture data.

21. The device according to claim 20, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated.

22. A device for displaying a picture in a mobile terminal, which comprises:
a direction detecting section comprising a magnet fixed within the mobile terminal and a plurality of sensors for detecting the polarity of the magnet in order to detect the direction in which the mobile terminal is turned and generate a first direction detecting signal, a second direction detecting signal, a third direction detecting signal, and a fourth direction detecting signals;
a control section for outputting picture data having an orientation based on the detected direction; and
a display section for displaying the picture data.

23. The device according to claim 22, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated.

24. The device according to claim 22, wherein said direction detecting section includes:
a magnet fixed within the mobile terminal;
first and second sensors for detecting the N pole of the magnet; and
third and fourth sensors for detecting the S pole of the magnet.

25. The device according to claim 22, wherein said direction detecting section includes:
a magnet fixed within the mobile terminal; and
first and second sensors for detecting the N pole and S pole of the magnet.

26. A device for displaying a picture in a mobile terminal, which comprises:
a direction detecting section comprising a magnet fixed within the mobile terminal, first and second sensors for detecting the N pole of the magnet and third and fourth sensors for detecting the S pole of the magnet in order to detect the direction in which the mobile terminal is turned according to the pole detected by one of the four sensors and generate a first direction detecting signal, a second direction detecting signal, a third direction detecting signal, and a fourth direction detecting signal;
a control section for outputting picture data having an orientation based on the detected direction; and
a display section for displaying the picture data.

27. The device according to claim 26, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated.

28. A device for displaying a picture in a mobile terminal, which comprises:
a direction detecting section comprising a magnet fixed within the mobile terminal and first and second sensors for detecting the N and S poles of the magnet in order to detect the direction in which the mobile terminal is turned according to the pole detected by one of the two sensors and generate a first direction detecting signal, a second direction detecting signal, a third direction detecting signal, and a fourth direction detecting signal;
a control section for outputting picture data in an upright direction having an orientation based on the detected direction; and
a display section for displaying the picture data.

29. The device according to claim 28, wherein said control section outputs data in an upright direction when the first direction detecting signal is generated, in a direction turned 90° counter-clockwise when the second direction detecting signal is generated, in a direction turned 180° when the third direction detecting signal is generated, or in a direction turned 270° counter-clockwise when the fourth direction detecting signal is generated.

30. A method for displaying a picture on a mobile terminal which includes a direction detecting section comprising at least one fixed magnet and a plurality of sensors for detecting the magnet, said method comprising the steps of:
detecting a direction signal indicating the direction in which the mobile terminal is turned, using the sensors for detecting the magnet; and
outputting and displaying picture data in an orientation based on the detected signal.

31. The method according to claim 30, wherein when no direction signal is received from the sensors, making a determination as to when a first direction signal is detected and outputting and displaying picture data in an upright direction;
when a second direction signal is detected, outputting and displaying the picture data in a direction turned 90° counter-clockwise;
when a third direction signal is detected, displaying the picture data in a direction turned 180°; and
when a fourth direction signal is detected, outputting and displaying the picture data in a direction turned 270° counter-clockwise.

32. The method according to claim 30, wherein said direction detecting section, if composed of first and second magnets and the first sensor, the second sensor, the third sensor and the fourth sensor for detecting the first and second magnets, generates:
the first direction signal when no direction detecting signal is output from the sensors, thereby displaying the picture data in the upright direction;
the second direction signal when the second sensor detects the first magnet, thereby displaying the picture data in a direction turned 90° counter-clockwise;
the third direction signal when the second sensor detects the first magnet and simultaneously the third sensor detects the second magnet, thereby displaying the picture data in a direction turned 180°; and
the fourth direction signal when the first sensor detects the first magnet, thereby displaying the picture data in a direction turned 270° counter-clockwise.

33. A method for displaying a picture on a mobile terminal which includes a direction detecting section comprising at least one fixed magnet and a plurality of sensors for detecting the magnet, said method comprising the steps of:
detecting a direction signal indicating the direction in which the mobile terminal is turned, using a sensor contacting the magnet; and
outputting and displaying picture data in an orientation based on the detected signal.

34. The method according to claim 33, wherein when no direction signal is received from the sensors, making a determination as to when a first direction signal is detected and outputting and displaying picture data in an upright direction;
when a second direction signal is detected, outputting and displaying the picture data in a direction turned 90° counter-clockwise;
when a third direction signal is detected, displaying the picture data in a direction turned 180°; and
when a fourth direction signal is detected, outputting and displaying the picture data in a direction turned 270° counter-clockwise.

35. The method according to claim 33, wherein said direction detecting section, if composed of first and second magnets and the first sensor, the second sensor, the third sensor and the fourth sensor for detecting the first and second magnets, generates:
the first direction signal when no direction detecting signal is output from the sensors, thereby displaying the picture data in the upright direction;
the second direction signal when the second sensor detects the first magnet, thereby displaying the picture data in a direction turned 90° counter-clockwise;
the third direction signal when the second sensor detects the first magnet and simultaneously the third sensor detects the second magnet, thereby displaying the picture data in a direction turned 180°; and
the fourth direction signal when the first sensor detects the first magnet, thereby displaying the picture data in a direction turned 270° counter-clockwise.

36. A method for displaying a picture on a mobile terminal which includes a direction detecting section comprising at least one projection and a plurality of sensors for detecting the projection, said method comprising the steps of:
detecting a direction signal indicating the direction in which the mobile terminal is turned, using a sensor contacting the projection; and
outputting and displaying picture data in an orientation based on the detected signal.

37. The method according to claim 36, wherein when no direction signal is received from the sensors, making a determination as to when a first direction signal is detected and outputting and displaying picture data in an upright direction;
when a second direction signal is detected, outputting and displaying the picture data in a direction turned 90° counter-clockwise;
when a third direction signal is detected, displaying the picture data in a direction turned 180°; and
when a fourth direction signal is detected, outputting and displaying the picture data in a direction turned 270° counter-clockwise.

38. The method according to claim 36, wherein said direction detecting section, if composed of first and second projections fixed on the outer side of a folder of the mobile terminal, second and fourth projections fixed on the inner side of the folder, and first, second and third sensors for detecting the first, second, third and fourth projections, generates:
the first direction signal when no direction detecting signal is output from the sensors, thereby displaying the picture data in the upright direction;
the second direction signal when the second sensor detects the third projection, thereby displaying the picture data in a direction turned 90° counter-clockwise;
the third direction signal when the second sensor detects the first projection and simultaneously the third sensor detects the second projection, thereby displaying the picture data in a direction turned 180°; and
the fourth direction signal when the first sensor detects the first projection, thereby displaying the picture data in a direction turned 270° counter-clockwise.

39. A method for displaying a picture on a mobile terminal which includes a direction detecting section comprising at least one projection and a plurality of sensors for detecting the projection, said method comprising the steps of:
detecting a direction signal indicating the direction in which the mobile terminal is turned, using a sensor contacting the projection;
when no direction signal is received from the sensors, making a determination as to when a first direction signal is detected and outputting and displaying picture data in an upright direction;
when a second direction signal is detected, generating full size picture data and displaying the picture data in a direction turned 90° counter-clockwise;
when a third direction signal is detected, displaying the picture data in a direction turned 180°; and
when a fourth direction signal is detected, generating full size picture data and displaying the picture data in a direction turned 270° counter-clockwise.

40. The method according to claim 39, wherein when no direction signal is received from the sensors, making a determination as to when a first direction signal is detected and outputting and displaying picture data in an upright direction;
when a second direction signal is detected, outputting and displaying the picture data in a direction turned 90° counter-clockwise;
when a third direction signal is detected, displaying the picture data in a direction turned 180°; and
when a fourth direction signal is detected, outputting and displaying the picture data in a direction turned 270° counter-clockwise.

41. The method according to claim 39, wherein said direction detecting section, if composed of first and second projections fixed on the outer side of a folder of the mobile terminal, second and fourth projections fixed on the inner side of the folder, and first, second and third sensors for detecting the first, second, third and fourth projections, generates:
the first direction signal when no direction detecting signal is output from the sensors, thereby displaying the picture data in the upright direction;
the second direction signal when the second sensor detects the third projection, thereby displaying the picture data in a direction turned 90° counter-clockwise;
the third direction signal when the second sensor detects the first projection and simultaneously the third sensor detects the second projection, thereby displaying the picture data in a direction turned 180°; and
the fourth direction signal when the first sensor detects the first projection, thereby displaying the picture data in a direction turned 270° counter-clockwise.

42. A method for displaying a picture on a mobile terminal which includes a direction detecting section comprising at least one projection, at least one magnet and a plurality of sensors for detecting the projection or the magnet, said method comprising the steps of:
detecting a direction signal indicating the direction in which the mobile terminal is turned, using a sensor contacting the projection or the magnet; and
outputting and displaying picture data in an orientation based on the detected signal.

43. The method according to claim 42, wherein when no direction signal is received from the sensors, making a determination as to when a first direction signal is detected and outputting and displaying picture data in an upright direction;
when a second direction signal is detected, outputting and displaying the picture data in a direction turned 90° counter-clockwise;
when a third direction signal is detected, displaying the picture data in a direction turned 180°; and
when a fourth direction signal is detected, outputting and displaying the picture data in a direction turned 270° counter-clockwise.

44. The method according to claim 42, wherein said direction detecting section, if composed of a projection, first and second magnets and first, second and third sensors for detecting the projection and the first and second magnets, generates:
the first direction signal when no direction detecting signal is output from the sensors, thereby displaying the picture data in the upright direction;
the second direction signal when the second sensor detects the second magnet, thereby displaying the picture data in a direction turned 90° counter-clockwise;
the third direction signal when the first sensor detects the second magnet and simultaneously the second sensor detects the first magnet, thereby displaying the picture data in a direction turned 180°; and
the fourth direction signal when the first sensor detects the first magnet, thereby displaying the picture data in a direction turned 270° counter-clockwise.

45. A method for displaying a picture on a mobile terminal which includes a direction detecting section comprising at least one projection, at least one magnet and a plurality of sensors for detecting the projection or the magnet, said method comprising the steps of:
detecting a direction signal indicating the direction in which the mobile terminal is turned, using a sensor contacting the projection or the magnet;
when no direction signal is received from the sensors, making a determination as to when a first direction signal is detected and outputting and displaying picture data in an upright direction; and
outputting and displaying picture data in an orientation based on the detected signal.

46. The method according to claim 45, wherein when no direction signal is received from the sensors, making a determination as to when a first direction signal is detected and outputting and displaying picture data in an upright direction;
when a second direction signal is detected, outputting and displaying the picture data in a direction turned 90° counter-clockwise;
when a third direction signal is detected, displaying the picture data in a direction turned 180°; and
when a fourth direction signal is detected, outputting and displaying the picture data in a direction turned 270° counter-clockwise.

47. The method according to claim 45, wherein said direction detecting section, if composed of a projection, first and second magnets and first, second and third sensors for detecting the projection and the first and second magnets, generates:
the first direction signal when no direction detecting signal is output from the sensors, thereby displaying the picture data in the upright direction;
the second direction signal when the second sensor detects the second magnet, thereby displaying the picture data in a direction turned 90° counter-clockwise;
the third direction signal when the first sensor detects the second magnet and simultaneously the second sensor detects the first magnet, thereby displaying the picture data in a direction turned 180°; and
the fourth direction signal when the first sensor detects the first magnet, thereby displaying the picture data in a direction turned 270° counter-clockwise.

48. A method for displaying a picture on a mobile terminal which includes a direction detecting section comprising a fixed magnet and a plurality of sensors for detecting the polarity of the magnet, said method comprising the steps of:
detecting the polarity of the magnet by one of the sensors; detecting a direction signal indicating the direction in which the mobile terminal is turned according to the detected polarity; and
outputting and displaying picture data in an orientation based on the detected signal.

49. The method according to claim 48, wherein when no direction signal is received from the sensors, making a determination as to when a first direction signal is detected and outputting and displaying picture data in an upright direction;
when a second direction signal is detected, outputting and displaying the picture data in a direction turned 90° counter-clockwise;
when a third direction signal is detected, displaying the picture data in a direction turned 180°; and
when a fourth direction signal is detected, outputting and displaying the picture data in a direction turned 270° counter-clockwise.

50. The method according to claim 48, wherein said direction detecting section, if composed of a magnet fixed within the mobile terminal, first and second sensors for detecting the N pole of the magnet and third and fourth sensors for detecting the S pole of the magnet, generates:
the first direction signal when no direction detecting signal is output from the sensors, thereby displaying the picture data in the upright direction;
the second direction signal when the second sensor detects the N pole of the magnet, thereby displaying the picture data in a direction turned 90° counter-clockwise;
the third direction signal when the fourth sensor detects the S pole of the magnet, thereby displaying the picture data in a direction turned 180°; and
the fourth direction signal when the third sensor detects the S pole of the magnet, thereby displaying the picture data in a direction turned 270° counter-clockwise.

51. The method according to claim 48, wherein said direction detecting section, if composed of a magnet fixed within the mobile terminal, first and second sensors for detecting the S pole of the magnet and third and fourth sensors for detecting the N pole of the magnet, generates:
the first direction signal when no direction detecting signal is output from the sensors, thereby displaying the picture data in the upright direction;
the second direction signal when the second sensor detects the S pole of the magnet, thereby displaying the picture data in a direction turned 90° counter-clockwise;
the third direction signal when the fourth sensor detects the N pole of the magnet, thereby displaying the picture data in a direction turned 180°; and
the fourth direction signal when the third sensor detects the N pole of the magnet, thereby displaying the picture data in a direction turned 270° counter-clockwise.

52. The method according to claim 48, wherein said direction detecting section, if composed of a magnet fixed within the mobile terminal and first and second sensors for detecting the N and S poles of the magnet, generates:
the first direction signal when no direction detecting signal is output from the sensors, thereby displaying the picture data in the upright direction;
the second direction signal when the second sensor detects the N pole of the magnet, thereby displaying the picture data in a direction turned 90° counter-clockwise;
the third direction signal when the second sensor detects the S pole of the magnet, thereby displaying the picture data in a direction turned 180°; and
the fourth direction signal when the first sensor detects the S pole of the magnet, thereby displaying the picture data in a direction turned 270° counter-clockwise.

53. The method according to claim 48, wherein said direction detecting section, if composed of a magnet fixed within the mobile terminal and first and second sensors for detecting the N and S poles of the magnet, generates:
the first direction signal when no direction detecting signal is output from the sensors, thereby displaying the picture data in the upright direction;
the second direction signal when the second sensor detects the S pole of the magnet, thereby displaying the picture data in a direction turned 90° counter-clockwise;
the third direction signal when the second sensor detects the N pole of the magnet, thereby displaying the picture data in a direction turned 180°; and
the fourth direction signal when the first sensor detects the N pole of the magnet, thereby displaying the picture data in a direction turned 270° counter-clockwise.
